(19) United States
(12) Patent Application Publication
(10) Pub. No.: US 2010/0066235 A1
(43) Pub. Date: Mar. 18, 2010

(54) IMAGE DISPLAY APPARATUS

(75) Inventors: Kazunari Ooyama, Numazu-shi (JP); Hiroko Takada, Isehara-shi (JP); Shinichi Kawate, Sagamihara-shi (JP); Masafumi Kyogaku, Yokohama-shi (JP); Noriaki Homma, Hachioji-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/556,346

(22) Filed: Sep. 9, 2009

(30) Foreign Application Priority Data
Sep. 18, 2008 (JP) 2008-239156

(51) Int. Cl. H01J 1/62

(52) U.S. Cl. 313/496

(57) ABSTRACT

The shortest distance L [μm] from an arbitrary point on an exposed insulating surface on a base to a conductive member on the base and a sheet resistivity Rs [Ω/□] of the arbitrary point satisfy Rs×L²<4.2×10²² [Ω×μm²]. By this, in an image display apparatus having an electron-emitting device, an increase in the potential of an insulating surface on a substrate is suppressed and deterioration in the electron-emitting device is prevented, without using an antistatic film, etc.

### BACKGROUND OF THE INVENTION

1. Field of the Invention

The present invention relates to an image display apparatus using electron-emitting devices.

2. Description of the Related Art

In an image display apparatus (FED) using field emission electron-emitting devices, light is emitted by irradiating electrons to a light emitting member such as a phosphor. As disclosed in FIG. 3, etc., in Japanese Patent Application Laid-Open No. 09-063516, such an image display apparatus is generally configured such that a rear plate 1 which is a substrate having a plurality of electron-emitting devices disposed thereon and a face plate 31 which is a substrate having a light emitting layer 32 such as a phosphor disposed thereon are disposed so as to face each other. Then, in order to obtain predetermined display characteristics such as practical brightness, a conductive film 33, called a metal back, is disposed on a side of the light emitting layer 32 that faces the rear plate 1.

FIGS. 13A and 13B are schematic views showing a rear plate of an FED using typical Spindt-type field emission electron-emitting devices. FIG. 13A is a schematic plan view thereof and FIG. 13B is a schematic cross-sectional view taking along line A-A′ of FIG. 13A. In the drawings, reference numeral 131 denotes a gate, 132 denotes an electron-emitting portion (Spindt-type emitter), 133 denotes an insulating layer, 134 denotes a cathode, 135 denotes an insulating substrate, and 136 denotes an opening (hole).

The example shown in FIGS. 13A and 13B shows a configuration in which Spindt-type field emission electron-emitting devices are matrix-wired (configuration in which wirings to which a scanning signal is applied intersect wirings to which a modulation signal is applied).

Insulating surfaces (surfaces of insulating members such as the insulating layer 133 and the insulating substrate 135) are exposed with respect to a face plate (not shown) unless covered by a conductive film, etc. When the sheet resistivities of the exposed insulating surfaces is high, the potentials of the insulating surfaces rise during the drive of the image display apparatus, depending on the configuration of the rear plate. As a result, a discharge occurs between the insulating surfaces and the electron-emitting devices or between the insulating surfaces and the gates, etc., which may deteriorate the electron-emitting devices.

Japanese Patent Application Laid-Open Nos. 09-063516 and 10-134701 disclose the provision of a film (antistatic film) for suppressing an increase in the potentials of insulating surfaces, on a rear plate. Also, “Origin of secondary-electron-emission yield-curve parameters by Gerald F. Dionne, Journal of Applied Physics, Vol. 46, Issue 8, pp. 3347-3351, 1975” discloses secondary electron emission efficiency that affects an increase in the potentials of insulating surfaces.

### SUMMARY OF THE INVENTION

In an FED, a high voltage (e.g., 10 kV or more) is applied between an electron-emitting device and a light emitting layer (between a rear plate and a face plate). In this case, electrons emitted from the electron-emitting device having high energy (e.g., 10 keV or more) enter the face plate. When the electrons having energy of 10 keV or more, for example, enter the face plate, an X-ray having energy of 10 keV or less (characteristic X-ray of elements constituting the face plate (particularly, the light emitting layer and a metal back)) is produced.

It has been found that when a photon beam having the X-ray as a main component is irradiated onto an insulating surface on the rear plate, charge occurs by photoelectric effect and as a result the potential of the insulating surface increases. This phenomenon theoretically does not occur under circumstances where all X-rays radiated from the face plate to insulating surfaces are shielded.

Here, the state “circumstances where all X-rays are shielded” is achieved when the insulating surfaces are covered by a shielding material. The expression “when the insulating surfaces are covered by a shielding material” refers to when shielding materials that shield X-rays are present in segments of all straight lines connecting an arbitrary point on the insulating surfaces and arbitrary X-ray emitting points on the face plate.

The shielding materials can be conductive members such as electrodes or wirings disposed on the rear plate. Also, structures disposed between the face plate and the rear plate can become the shielding materials. The term “structures” as used herein refer to, for example, spacers or electrodes for controlling electron trajectories, which are disposed between the face plate and the rear plate. The structures can become shielding materials when the lengths in the structures along the segments of straight lines are greater than or equal to an X-ray attenuation length.

Furthermore, in addition to the X-ray, some of electrons emitted from the electron-emitting device reach the insulating surface during the drive of the image display apparatus. As a result, secondary electron emission may occur at an insulating surface in the vicinity of the electron-emitting device.

Here, the ratio of the number of electrons coming out of an insulating surface to the number of electrons emitting from an electron-emitting device and entering the insulating surface is δ. It has been found that when the potential difference between the cathode of an electron-emitting device and an insulating surface is increased due to the increase in the potential of the insulating surface caused by the X-ray, in some cases, δ exceeds one. When δ exceeds one, entering of emitted electrons from the electron-emitting device onto the insulating surface causes positive charge to be continuously generated on the insulating surface, leading to a further increase in the potential of the insulating surface.

As described above, when the sheet resistivity of an insulating surface is high, by an X-ray (a photon beam having an X-ray as a main component) entering the insulating surface during the drive of the image display apparatus, the potential of the insulating surface may continuously increase. As a result, a discharge occurs between the insulating surface and an electron-emitting device or between the insulating surface and a conductive member such as a wiring, which may deteriorate the electron-emitting device.

To avoid such a problem, as shown in Japanese Patent Application Laid-Open Nos. 09-063516 and 10-134701, by covering insulating surfaces having a high sheet resistivity by a film having a low sheet resistivity, an increase in the potentials of the insulating surfaces can be suppressed. The above-described method, however, has a problem that since a step of covering insulating surfaces by a film having a low sheet resistivity is required, the manufacturing cost significantly increases. Furthermore, there is another problem that when insulating surfaces are covered by a film having a low sheet resistivity, electron emission characteristics may be affected thereby.

The present invention is made in view of the foregoing problems and proposes an image display apparatus that has excellent display characteristics and can suppress deterioration in electron-emitting devices caused by discharge and can be manufactured at low cost.

The present invention is directed to an image display apparatus including:

a first substrate having a base with an insulating surface; an electron-emitting device formed on the base; wirings connected to the electron-emitting device; and an insulating member that insulates a conductive member such as the wirings and electrodes of the electron-emitting device; and

a second substrate having an anode facing the electron-emitting device; and a light emitting member that emits light by irradiation of electrons emitted from the electron-emitting device, and disposed so as to face the first substrate, wherein

a shortest distance L [μm] from an arbitrary point on each of an exposed surface of the surface of the base and an exposed surface of an insulating member, to the conductive member on the base, and a sheet resistivity Rs [Ω/□] at the arbitrary point satisfy a following equation (1):

Rs×L²<4.2×10²² [Ω×μm²] (1)

In the present invention, it is preferred that the L and the Rs satisfy a following equation (2):

Rs×L²<1.8×10²¹ [Ω×μm²] (2)

Also, in the present invention, it is preferred that the insulating surface of the first substrate have silicon oxide as a main component and have a sheet resistivity of 1×10¹⁶ Ω/□ or more.

According to the present invention, since an increase in the potentials of insulating surfaces is suppressed to a level that does not affect electron emission, an image display apparatus can be provided that has excellent display characteristics and can suppress deterioration in electron-emitting devices caused by discharge and can be manufactured at low cost.

### BRIEF DESCRIPTION OF THE DRAWINGS

FIG. 1 is a schematic plan view showing a configuration of a rear plate of an example of an image display apparatus in the present invention;

FIG. 2 is a schematic cross-sectional view of the example of an image display apparatus in the present invention;

FIGS. 3A to 3F are schematic plan views showing a fabrication process of the rear plate in FIG. 1;

FIG. 4 is a diagram showing a relationship between secondary electron emission coefficient δ of an insulating surface and energy E of entered electrons reaching the insulating surface, in the present invention;

FIGS. 5A and 5B are diagrams for describing a relationship between the shape and potential of an insulating surface, in the present invention;

FIG. 6 is a diagram showing a relationship between the accelerating voltage Va of an electron beam and the electron-to-photon conversion efficiency δex of a face plate in a test image display apparatus in the present invention;

FIGS. 7A and 7B are diagrams showing a relationship between the entrance angle and attenuation length of an X-ray when the X-ray radiated from the face plate enters an insulating surface of the rear plate, in the present invention;

FIG. 8 is a diagram showing i_{80d}/i_{1d} of the test image display apparatus in the present invention;

FIG. 9 is a diagram showing a relationship between (η-ηᵥ₌₀)/ηᵥ₌₀ and V obtained by electron orbital calculation in the present invention;

FIG. 10 is a diagram showing measurement results of the behavior of η for when the test image display apparatus in the present invention is driven;

FIG. 11 is a schematic plan view of a rear plate according to a first implemental example of the present invention;

FIGS. 12A and 12B are schematic views of a rear plate according to a second implemental example of the present invention; and

FIGS. 13A and 13B are schematic views of a rear plate of a conventional FED image display apparatus.

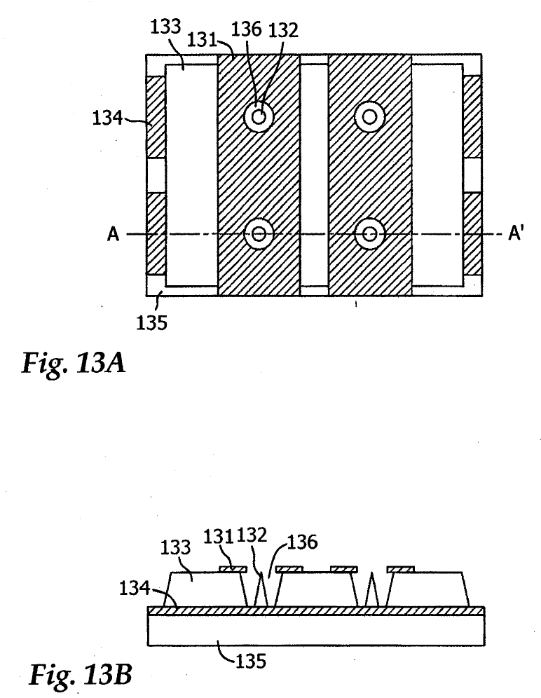

### DESCRIPTION OF THE EMBODIMENTS

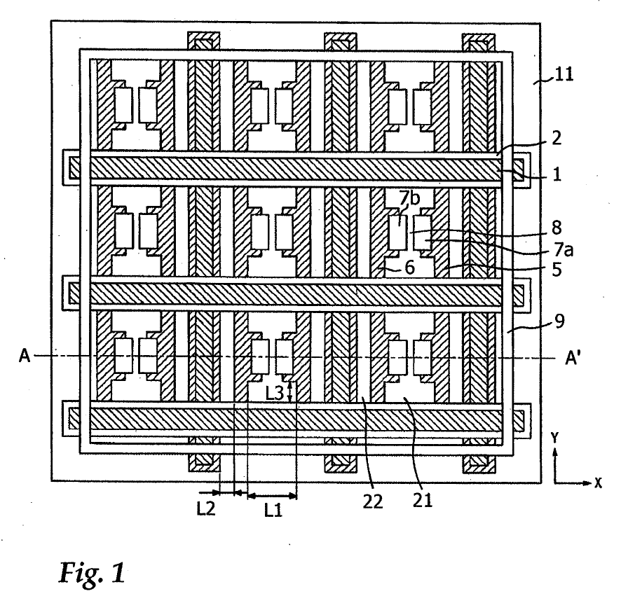

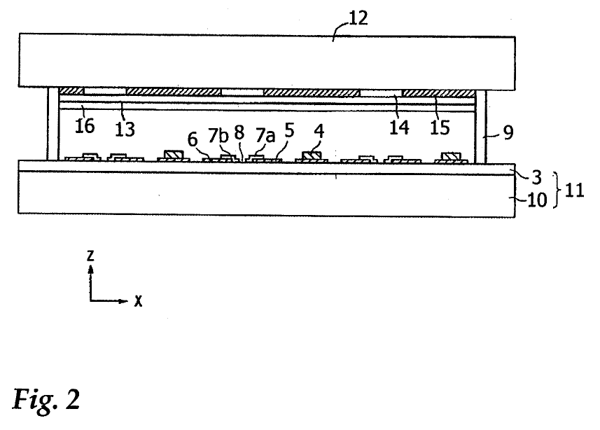

An embodiment of the present invention is shown in FIGS. 1 and 2. FIG. 1 is a schematic plan view showing a part of an electron source (first substrate; rear plate) having a plurality of electron-emitting devices which are matrix-wired on a substrate 11. FIG. 2 is a schematic cross-sectional view of an image display apparatus in which a face plate (second substrate) is disposed so as to face the rear plate in FIG. 1, and corresponds to a cross section taking along line A-A′ of FIG. 1.

FIGS. 1 and 2 show an example using surface conduction electron-emitting devices as electron-emitting devices. However, in the present invention, field emission electron-emitting devices of a Spindt-type, a BSD-type, an MIM-type, etc., field emission electron-emitting devices using carbon fiber such as a carbon nanotube, and the like, can also be used.

In FIGS. 1 and 2, reference numeral 1 denotes a first wiring (row-direction wiring), 2 denotes an insulating layer, 10 denotes a base, 3 denotes an insulating coat layer, 4 denotes a second wiring (column-direction wiring), and 11 denotes a substrate. A surface conduction electron-emitting device includes electrodes 5 and 6 and a pair of conductive films 7a and 7b spaced by a spacing 8. The electrodes 5 and 6 and the conductive films 7a and 7b are respectively electrically connected to each other.

Each row direction wiring 1 is disposed on the insulating layer 2 and is connected to corresponding first electrodes 6 through contact holes (openings), which are not shown, provided in the insulating layer 2. The insulating layer 2 covers a part of the column-direction wirings 4. Each column-direction wiring 4 is stacked on a part of corresponding second electrodes 5 and is connected to the second electrodes 5. By providing a drive voltage Vf between the first electrode 6 and the second electrode 5 through corresponding wirings 1 and 4, electrons are emitted from the vicinity of a corresponding spacing 8.

Although in FIG. 2 the substrate 11 is composed of the base 10 and the insulating coat layer 3, when a surface of the base 10 is an insulating surface, the base 10 itself can compose the substrate 11 without additionally providing the insulating coat layer 3 on the base 10.

Also, although, in the configuration shown in FIGS. 1 and 2, reference numeral 3 denotes an insulating coat layer and 2 denotes an insulating layer, surfaces of the insulating coat layer 3 and the insulating layer 2 both are insulating surfaces. Note that an “insulating surface” refers to an exposed surface that is not covered by a conductive member, such as a portion between conductive members (e.g., between electrodes 5 and 6 or between wirings 1 and 4), and refers to a surface of an insulating member that electrically sufficiently insulates between conductive members.

In the present invention, a distance (shortest distance) L [μm] connecting an arbitrary point on the insulating surface and a point on a conductive member closest to the arbitrary point and a sheet resistivity Rs [Ω/□] at the arbitrary point satisfy the following equation (1):

Rs×L²<4.2×10²² [Ω×μm²] (1)

Preferably, they satisfy the following equation (2):

Rs×L²<1.8×10²¹ [Ω×μm²] (2)

When a surface of the substrate 11, i.e., the insulating coat layer 3 or a surface of the base 10, has silicon oxide as a main component, the sheet resistivity Rs thereof is preferably 1×10¹⁶ (Ω/□) or more.

By satisfying the above-described equation (1), deterioration in electron-emitting devices caused by, for example, discharge resulting from charging on insulating surfaces by X-rays can be suppressed without using an antistatic film which is conventionally required. As a result, the image display apparatus can obtain a stable display image over an extended period of time.

The face plate has an anode facing the electron-emitting devices and light emitting members that emit light by irradiation of electrons emitted from the electron-emitting devices. In FIG. 2, a substrate 12 is composed of a transparent material such as a glass. On a surface of the substrate 12 on the electron-emitting device side is stacked a phosphor film having phosphors (light emitting members) 14 and a light-shielding layer 15 composed of a black member such as a black matrix. Furthermore, on a surface of the phosphor film on the electron-emitting device side are stacked a metal back (anode) 13 composed of a conductive film such as an aluminum film with a thickness of 1000 Å to 2000 Å and a getter 16. The gap between the rear plate and the face plate is 0.5 mm or more and 5 mm or less.

By applying a potential difference Va between the anode 13 and an electron-emitting device, electrons emitted from the vicinity of a corresponding spacing 8 pass through the anode 13 and then are irradiated to a corresponding phosphor 14. To obtain practical display characteristics, the potential difference (Va) provided between the electron-emitting device and the anode 13 (typically, between a first electrode 6 and the anode 13) is several kV to several tens of kV and is typically 10 kV or more. Also, to obtain practical display characteristics, electrons (emission current Ie) that are emitted from the electron-emitting device and reach the phosphor 14 need to be 1.5 μA≦Ie≦4.5 μA at the point when the electrons are irradiated to the phosphor 14.

Note that in an image display apparatus in the present invention it is preferred to provide conventionally-known plate-like spacers on some of the row-direction wirings 1 or on all of the row-direction wirings 1 along the row-direction wirings 1.

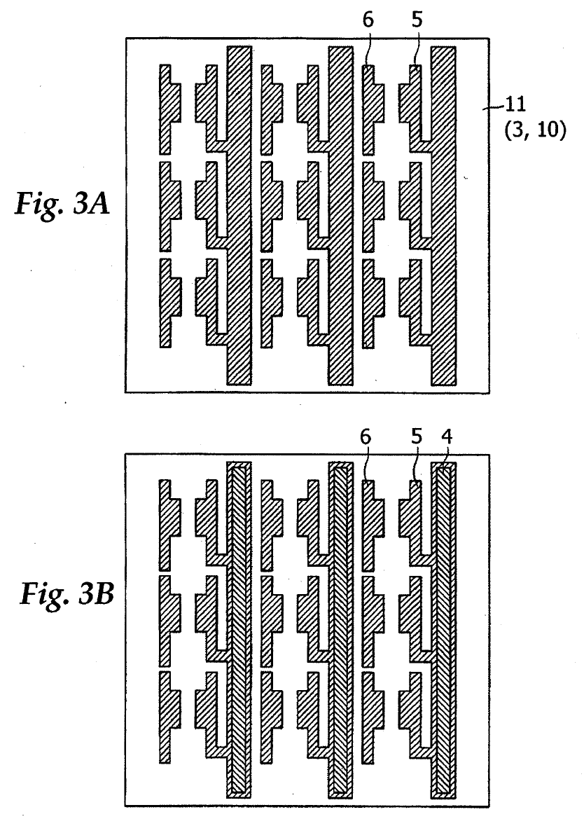

A fabrication method of the above-described rear plate will be briefly described below using FIGS. 3A to 3F.

First, first electrodes 5 and second electrodes 6 are formed on a substrate 11 having an insulating surface (FIG. 3A). The substrate 11 having an insulating surface can be configured, as in the present example, by providing an insulating coat layer 3 on a base 10. Of course, if a surface of a substrate has a sufficient sheet resistivity which will be described later, electrodes 5 and 6 can be formed on the surface of the base 10 without providing an insulating coat layer 3 on the base 10. For the insulating coat layer 3, it is preferred to use an insulating film having silicon oxide as a main component.

For the base 10, a glass such as a quartz glass, a high strain point glass, or a soda-lime glass is preferably used. The insulating coat layer 3 can be formed by a known deposition method such as a sputtering method or CVD method, after thoroughly cleaning the base 10 by cleaner, pure water, and an organic solvent.

When electron-emitting devices to be used are surface conduction electron-emitting devices, in order to favorably perform “current passing forming” and “activation” which will be described later, it is practically desirable that the sheet resistivity of the insulating coat layer 3 be 1×10¹⁶ Ω/□ or more. Also, in the case of using other types of electron-emitting devices (particularly, field emission electron-emitting devices), too, similarly, it is practically desirable that the sheet resistivity of the insulating coat layer 3 be 1×10¹⁶ Ω/□ or more.

For the electrodes 5 and 6, a method can be selected in which, for example, after a film is deposited by a vacuum deposition method, a sputtering method, a plasma CVD method, or the like, the film is patterned by a lithography method, followed by etching. A material of the electrodes 5 and 6 can be any as long as the material has conductivity. Examples of the material include a metal such as Ni, Cr, Au, Mo, W, Pt, Ti, Al, Cu, or Pd or an alloy. The patterns of the first electrodes 5 and the second electrodes 6 are not limited to those shown in FIG. 3A.

Then, column-direction wirings 4 which are connected to the electrodes 5 are provided (FIG. 3B). The column-direction wirings 4 can be formed by, for example, printing a conductive paste and baking the paste. At this time, the column-direction wirings 4 are formed so as to be connected to the electrodes 5. In the present example, by providing the column-direction wirings 4 on a part of the electrodes 5, the electrodes 5 and the column-direction wirings 4 are connected to each other. For the film thickness of the wirings, a thicker thickness can reduce the electrical resistance and thus is advantageous. Therefore, it is preferred to use a printing method, particularly, a screen printing method, and preferred to use a paste (conductive paste) including metal particles such as silver, gold, copper, or nickel. To form wirings with a finer pattern, a conductive paste having a photosensitive component added thereto is used and the conductive paste is deposited on a substrate by a printing method and thereafter exposure and development are performed, whereby wirings 4 can be formed. Note that after forming a predetermined pattern, to remove vehicle components in a paste, baking is performed at a temperature (400 to 650° C.) according to the thermal characteristics of the paste and a substrate to be used.

Subsequently, insulating layers 2 are provided (FIG. 3C). FIG. 3C is a diagram showing a state in which the insulating layers 2 are formed on the insulating coat layer 3, the electrodes 5, the electrodes 6, and the column-direction wirings 4. For a main component composing the insulating layers 2, for example, practically, silicon oxide (typically, SiO₂) is selected. The thickness can be any as long as the thickness can ensure insulation. The insulating layers 2 are formed by sputtering or CVD. Reference numeral 2a denotes an opening provided in the insulating layers 2. Each opening 2a communicates with a region including a location where a corresponding electrode 6 is disposed.

FIGS. 3D and 3E are diagrams showing a state in which row-direction wirings 1 are formed on the insulating layers 2, the electrodes 6, and the insulating coat layer 3. FIG. 3D is a plan view and FIG. 3E is a cross-sectional view taken along line A-A′ of FIG. 3D.

For the row-direction wirings 1, too, a lower electrical resistance is advantageous and thus it is preferred to use a thick film printing method by which a film can be formed to a thick film thickness. Hence, as with the formation of the column-direction wirings 4, wirings are formed by a screen printing method, using a conductive paste and thereafter baking is performed.

As shown in FIG. 3E, each row-direction wiring 1 is disposed on corresponding electrodes 6 through openings 2a in a corresponding insulating layer 2. While the row-direction wiring 1 is electrically connected to the electrodes 6, the row-direction wiring 1 is not electrically connected to the column-direction wirings 4 or corresponding electrodes 5 by the presence of the insulating layer 2.

FIG. 3F is a diagram showing a state in which conductive films 7a and 7b are formed on the electrodes 5, the electrodes 6, and the insulating coat layer 3 and spacing 8 is formed between each pair of conductive films 7a and 7b. Each spacing 8 can be formed such that, for example, a voltage is applied between electrodes 5 and 6 connected to each other by a conductive film, whereby a spacing 8 is formed at a part of the conductive film connecting the electrodes 5 and 6. Alternatively, the spacings 8 can be formed by performing conventionally-known current passing forming and current passing activation.

The reason that effects of the present invention can be obtained by satisfying the aforementioned equation (1) will be described below.

First, the potential of an insulating surface will be described.

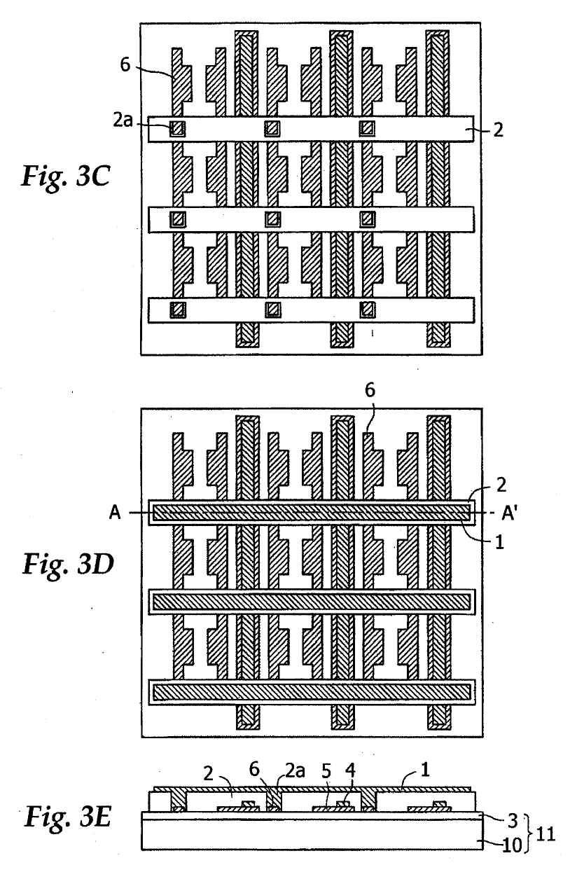

When an electron beam enters or a photon beam is irradiated onto an insulating surface, secondary electron emission or photoelectric effect occurs. The amount of charge generated on the insulating surface by the secondary electron emission is determined by a secondary electron emission coefficient δ of the insulating surface. δ is the ratio of the number of secondary electrons to the number of entered electrons. δ is a function of energy E of entered electrons that reach the insulating surface. FIG. 4 is a diagram showing a relationship between δ and E. In FIG. 4, E1 and E2 each are E having δ=1.

E1 is called a first crossover energy and E2 is called a second crossover energy.

Incident electrons onto the insulating surface are considered to be electrons emitted from an electron-emitting device, i.e., electrons having energy that is dependent on the potential difference between a negative electrode of the electron-emitting device and the insulating surface.

When the incident electrons reach the insulating surface from the negative electrode, E is dependent on the potential difference ΔV between the negative electrode and the insulating surface.

As for the energy E of the incident electrons onto the insulating surface from the negative electrode, ΔV at which E takes E1 (E=E1) will be denoted by V_{E1} and ΔV at which E takes E2 (E=E2) will be denoted by V_{E2}. Since the potential of the negative electrode is fixed, ΔV is determined by the potential V of the insulating surface.

The vicinity of El will be considered. When ΔV is such that E<E1, δ<1. The number of secondary electrons is smaller than the number of entered electrons and thus the amount of charge changes in a negative direction. Accordingly, ΔV is reduced and δ is also reduced.

On the other hand, when ΔV is such that E>E1, δ>1. The number of secondary electrons is larger than the number of entered electrons and thus the amount of charge changes in a positive direction. Accordingly, ΔV is increased and δ is also increased. This cycle continues until ΔV=V_{E2}, i.e., ΔV is such that E=E2. When E>E2, δ<1 and thus the amount of charge changes in the negative direction and accordingly an increase in ΔV is suppressed. Hence, an increase in ΔV is settled at ΔV=V_{E2}.

According to Dionne, when the insulating surface is of SiO₂, E1=44 eV from TABLE 1, and Emax≈200 eV and δmax≈1.63 from FIG. 4. The value of the above-described E1 is a value in which the entrance angle of entered electrons is 0°. That is, the value is realized in case the angle between the path of entered electrons in the vicinity of the insulating surface and the direction of the insulating surface (a direction vertical to a direction in the insulating surface) is 0°.

E1 is dependent on the incident angle. The greater the incident angle, the smaller E1.

Dionne shows that E2 is obtained from Emax and δmax. E2 is estimated to be several keV from the above-described values of Emax and δmax for SiO₂. This can also be estimated from a theoretical equation in Dionne.

When the insulating surface is of SiO₂ and electrons enter the insulating surface, if the potential difference ΔV between the negative electrode and the insulating surface is smaller than V_{E1}, secondary electron emission acts to reduce ΔV. On the other hand, if ΔV is greater than V_{E1}, secondary electron emission acts to increase ΔV and attempts to increase ΔV to V_{E2}, i.e., several kV.

The above-described change in the potential of the insulating surface occurs due to secondary electron emission caused by electrons that reach the insulating surface from the negative electrode. On the other hand, there is a change in the potential of the insulating surface that occurs due to photoelectric effect caused by photons that reach the insulating surface from the face plate.

During the drive of an image display apparatus using electron-emitting devices, a photon beam having X-rays as a main component is irradiated onto insulating surfaces composing the electron-emitting devices. The X-rays are produced in a manner such that emitted electrons from the electron-emitting devices are accelerated by a voltage Va of several kV to several tens of kV applied between the electron-emitting devices and an anode and then enter a face plate.

The X-rays have a characteristic energy spectrum for materials composing the face plate, and by irradiation of the X-rays photoelectric effect occurs on the insulating surfaces. By this, positive charge is generated on the insulating surfaces, increasing the potentials of the insulating surfaces.

While an increase in potential by secondary electron emission does not occur unless the potential difference ΔV between a negative electrode and an insulating surface exceeds V_{E1}, an increase in potential by a photon beam occurs if photons having energy that causes photoelectric effect are irradiated. Meanwhile, when an increase in potential by secondary electron emission occurs as a result of the potential difference ΔV exceeding V_{E1}, the potential difference ΔV between the negative electrode and the insulating surface increases to V_{E2}, increasing the possibility that a discharge may occur between a conductive member and the insulating surface. Accordingly, the rear plate needs to be configured such that an increase in the potentials of insulating surfaces by photon beams is suppressed to V_{E1} or less during drive.

In addition to the above-described increase in the potentials of insulating surfaces caused by electrons and photons, there is possibly an increase in potential caused by ions. This increase in potential occurs such that, during the drive of the image display apparatus, molecules or atoms composing residual gas and existing between the rear plate and the face plate are ionized and reach insulating surfaces. However, the increase in the potentials of insulating surfaces caused by ions does not become a substantial problem in an atmosphere having a degree of vacuum of 10⁻⁶ Pa or more that is required for a display using surface conduction electron-emitting devices or field emission electron-emitting devices.

In an electron beam display, except for a single electron-emitting device composed of two electrodes, i.e., an anode and a negative electrode (cathode), etc., normally, an insulating member needs to be used for insulation between wirings or between electrodes. In the case of using an insulating member, unless a low resistance member or the like that covers a surface of the insulting member is used, the surface of the insulating member is exposed and electrons or photons are irradiated onto an insulating surface which is the exposed surface, during drive. Then, by an electron beam or photon beam being irradiated onto the insulating surface, secondary electron emission or photoelectric effect occurs for the reasons described above, generating positive charge on the insulating surface.

When positive charge is generated on the insulating surface, since the insulating surface has a high sheet resistivity, the potential of the insulating surface may increase to a level that affects the trajectory of electrons emitted from an electron-emitting device, depending on the configuration of the electron-emitting device.

Electron-emitting devices for use in a high-definition display, etc., practically need to be in a small size such as 10 μm to 500 μm. When such electron-emitting devices are disposed in a matrix, spacings between wirings and between electrodes have to be narrow. Hence, to ensure insulation between a plurality of wirings and between a plurality of electrodes, insulating surfaces having a higher sheet resistivity need to be used.

Therefore, in such electron-emitting devices, when insulating surfaces are exposed, a large potential difference may occur between conductive members and the insulating surfaces at a short length such as several μm to several tens of μm, depending on the configuration of the electron-emitting devices. In that case, a discharge occurs between the insulating surfaces and the conductive members which may deteriorate the electron-emitting devices.

When the potential difference ΔV between the negative electrode (cathode) and the insulating surface exceeds V_{E1}, due to secondary electron emission by electrons entering the insulating surface, the potential difference ΔV between the negative electrode and the insulating surface increases to V_{E2}, i.e., a potential of several kV, increasing the possibility that a discharge may occur between the insulating surface and a conductive member.

To estimate a potential of the insulating surface due to irradiation of a photon beam, the case will be considered in which charge flows toward the conductive member along the insulating surface.

First, the potential of an insulating surface in one electron-emitting device will be considered.

The insulating surface is of an arbitrary shape surrounded by a conductive member. The value of the shortest distance on the insulating surface from an arbitrary point on the insulating surface to the conductive member will be considered. At this time, the value of the shortest distance is determined for each of arbitrary points on the insulating surface. A set of the values of the shortest distances for all of the points on the insulating surface is considered and the maximum value in the set will be denoted by L.

When the shape of the insulating surface is a circle L is the radius, and when the shape of the insulating surface is a square L is the length of a half of the length of one side, and when the shape of the insulating surface is a rectangle L is the length of a half of the length of one narrow side. A point on the insulating surface whose shortest distance to the conductive member is L is, when the shape of the insulating surface is a circle, the center of the circle, and is, when the shape of the insulating surface is a square, the center of the square. When the shape of the insulating surface is a rectangle, points on the insulating surface whose shortest distances to the conductive member are L are a set of points on a line segment obtained by cutting out L from both ends of a line segment connecting the midpoints of two narrow sides.

For example, in FIG. 1, the conductive member includes the electrodes 5 and 6, the row-direction wirings 1, and the column-direction wirings 4, and the insulating surface includes exposed surfaces of the insulating coat layer 3 and the insulating layers 2.

Each insulating layer 2 is disposed between electrodes 5 and 6 and column-direction wirings 4 and a row-direction wiring 1 wired thereabove, so as to insulate between the electrodes 5 and 6 and the column-direction wiring 4 and the row-direction wiring 1. Therefore, while an insulating surface which is a surface of the insulating coat layer 3 has a substantially planar shape, an insulating surface which is a surface of the insulating layer 2 has a shape including a curved surface.

The above-described L is a distance along the substantially planar insulating surface of the insulating coat layer 3 and along the insulating surface of the insulating layer 2 including a curved surface and is not necessarily a distance of a segment of a straight line.

Next, a change in the potential of an insulating surface caused by irradiation of a photon beam onto the insulating surface will be described.

The amount of change in charge per unit area and per unit time (hereinafter, referred to as the “amount of charge per unit area and time”) that occurs due to photoelectric effect caused by irradiation of a photon beam onto the insulating surface will be denoted by i. As will be described later, i is dependent on the distance between a photon beam emitting point and a point on the insulating surface. The photon beam has, as a main component, a characteristic X-ray derived from constituent materials of the face plate and emitted from the face plate during the drive of the image display apparatus. Hereinafter, the “X-ray” refers to a “photon beam having an X-ray as a main component”.

In the image display apparatus, the distance between the insulating surface and the photon beam emitting point is sufficiently longer than the size of an insulating surface in one electron-emitting device. Therefore, i can be considered to be substantially the same at all locations on an insulating surface in one electron-emitting device. The potential of the insulating surface changes by i.

Now, it is assumed that at i=0 as an initial state the potential of the insulating surface is zero everywhere on the insulating surface. Under this condition, a change in the potential of the insulating surface caused by an increase in i will be considered.

The sheet resistivity Rs of the insulating surface is substantially uniform at all locations on the insulating surface in one electron-emitting device.

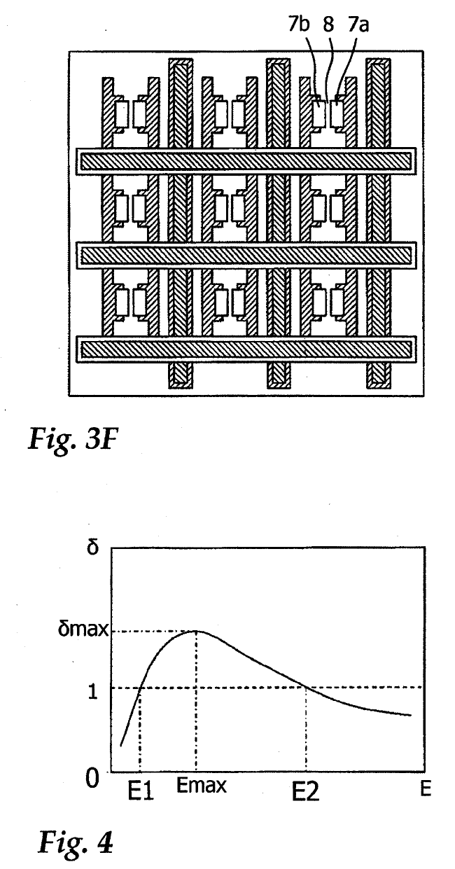

FIGS. 5A and 5B are diagrams describing potentials on insulating surfaces. FIG. 5A is a diagram for when the shape of the insulating surface is a circle and an insulating surface 31 is surrounded by a conductive member 32. In this shape, potential reaches its peak at the center of the circle of the insulating surface 31 and the maximum potential V is represented by the following equation (3):

V=(Rs×i×L²)/4 (3)

FIG. 5B is a diagram for when the shape of the insulating surface is such that the insulating surface continues for an infinite distance with a constant width and an insulating surface 31 is sandwiched by conductive members 32 for an infinite distance with a certain constant width. In this shape, potential reaches its peak on a straight line composed of a set of midpoints of the width and the maximum potential V is represented by the following equation (4):

V=(Rs×i×L²)/2 (4)

Next, the value of V for when the shape of the insulating surface is changed with L being constant will be considered. The maximum value of V is obtained by the shape shown in FIG. 5B and the minimum value of V is obtained by the shape shown in FIG. 5A. Therefore, the maximum potential V on an insulating surface of an arbitrary shape surrounded by conductive members is represented by the following equation (5):

(Rs×i×L²)/4≦V≦(Rs×i×L²)/2 (5)

The above-described insulating surface of an arbitrary shape may have not only a planar surface but also a curved surface. As will be described later, i is not dependent on the entrance angle θ of an X-ray onto the insulating surface but is only dependent on the distance r between an X-ray emitting point and the insulating surface. In a general structure of a display using electron-emitting devices, the length of a region occupied by an insulating surface in one electron-emitting device on a rear plate is very short as compared with the distance between the insulating surface and an X-ray emitting point. Thus, the above-described r can be considered to be uniform at all points on an insulating surface in one electron-emitting device.

Accordingly, in an insulating surface in one electron-emitting device, unless the incident angle of an X-ray is 90° or more, i.e., the entrance angle is one at which an X-ray enters the insulating surface from the back, whatever the curved surface is, i can be considered to be uniform (constant).

Note that potentials are not always V at all points on the insulating surface whose shortest distances to the conductive member are L. Potentials may be V at only some of the points whose shortest distances to the conductive member are L.

The above-described arbitrary shape of an insulating surface in one electron-emitting device on the rear plate also includes a shape in which the insulating surface is divided into a plurality of regions by a conductive member. In an insulating surface of such a shape, the largest L among Ls of respective divided regions is L of the entire insulating surface.

In the above-described equation (5), a physical quantity derived from the shape of the insulating surface is only L. Namely, the potential V of the insulating surface is characterized by L within the range of the above-described equation (5).

Hence, by controlling the value of L, the potential V of the insulating surface can be controlled within the range of the above-described equation (5) and thus the potential difference between the insulating surface and the conductive member can be controlled. As a result, a discharge that occurs between the insulating surface and the conductive member and deteriorates the electron-emitting device can be suppressed.

To show the effects of the present invention, rear plates shown in FIG. 1 are fabricated. To find a relationship between the drive characteristic of an image display apparatus and L, exemplary configurations of five types of the value of L1 in FIG. 1, L1=10 μm, 15 μm, 20 μm, 40 μm, and 57.5 μm, are prepared. For L2 and L3 in FIG. 1, in all the exemplary configurations, L2=10 μm and L3=652.5 μm. L2 in FIG. 1 satisfies L2≦L1.

In an exposed insulating surface of an insulating layer 2 that is not covered by a row-direction wiring 1, a spacing along the insulating surface that is sandwiched by the row-direction wiring 1 and an electrode 5, an electrode 6, and column-direction wirings 4 is much smaller than L1 and L2. Each insulating layer 2 insulates a corresponding row-direction wiring 1 and the column-direction wirings 4 in a vertical direction and thus has a certain amount of film thickness but the film thickness is much thinner than L1 and L2. Thus, a half of L1 corresponds to L of the insulating surface in this exemplary configuration. That is, L in this exemplary configuration is L=L1/2.

Note that since a region of an insulating surface 21 and a region of an insulating surface 22 in FIG. 1 are connected to each other through a surface of an insulating layer 2, the two regions are not divided by a conductive member. Therefore, the potential V of an insulating surface in FIG. 1 is dependent on L1. L3 is 10 times or longer than L1. Thus, it is considered that the potential V of an insulating surface of the rear plate can be approximately treated as the potential of an insulating surface of the shape shown in FIG. 5B.

As described above, the potential of an insulating surface that is determined by a photon beam irradiated onto the insulating surface is determined by i, Rs, and L. Of them, a quantity derived from the shape of the insulating surface is only L, and thus, by determining L with respect to provided i and Rs the potential V of the insulating surface can be controlled.

However, depending on the shape of the insulating surface, an influence such as that shown below may need to be taken into account during the drive of the image display apparatus.

During the drive of the image display apparatus, a drive voltage Vf is applied between the electrodes 5 and the electrodes 6 and an anode voltage Va is applied to the anode 13.

The drive voltage Vf and the anode voltage Va form a spatial potential distribution in the image display apparatus.

When an insulating surface in one electron-emitting device has a shape that cannot ignore a potential spatial change in the spatial potential distribution, the potential V of the insulating surface is not always determined only by i, Rs, and L. In this case, a potential distribution on the insulating surface is the sum of potentials on the insulating surface which is determined by a photon beam irradiated onto the insulating surface and a spatial potential generated by the application of the drive voltage Vf and the anode voltage Va.

Next, quantification of i will be described.

The i is, as described above, the amount of change in the amount of charge on an insulating surface per unit area and time that occurs due to photoelectric effect caused by irradiation of a photon beam onto the insulating surface. The above photon beam is a photon beam which comes from the face plate and which is emitted from an electron-emitting device and enters the face plate and comes from the face plate. The main component of the photon beam is a characteristic X-ray that is dependent on materials composing the face plate.

X-ray is emitted from light emitting members such as phosphor on the face plate where emitted-electrons from driven electron-emitting devices enter and is substantially immediate above each electron-emitting device.

At this time, i satisfies the following equation (6):

i=Σ(Φ/(2×π))×δxe×δex×Ie (6)

In equation (6),
Φ is the solid angle per unit area from each X-ray emitting point to a corresponding insulating surface,
δxe is the photon-to-electron conversion efficiency of the insulating surface,
δex is the electron-to-photon conversion efficiency of the face plate, and
Ie is the emission current from an electron-emitting device.

The sum is taken over all the X-ray emitting locations. (2×π) indicates the whole solid angle in space on one side partitioned by the planar face plate. The X-rays are assumed to be radiated substantially uniformly over the whole solid angle. Namely, a factor of (Φ/(2×π)) indicates the ratio of the amount of an X-ray reaching a unit area on an insulating surface of an electron-emitting device of interest to the total amount of X-rays emitted from the X-ray emitting points on the face plate.

The δex of the face plate can be found out by performing measurement as follows.

A sample having the same configuration as the face plate is prepared. By irradiating an electron beam to a phosphor on the sample, a characteristic X-ray is emitted. Note that by applying accelerating voltage Va between a surface of the sample and an electron-emitting source, an electron beam enters the surface of the sample. The emitted characteristic X-ray is received by a photoreceiver to count some of photons emitted from the face plate. A solid angle of a light-receiving portion of the photoreceiver as viewed from an X-ray emitting point is determined by the area of the light-receiving portion and the distance between the light-receiving portion and the X-ray emitting point. This solid angle will be denoted by ω. The number of photons emitted from the face plate will be denoted by Nx, the number of photons received by the light-receiving portion will be denoted by nx, and the number of electrons entering the face plate will be denoted by Ne. Then, δex is represented by the following equation (7):

δex=Nx/Ne=(nx×((2×π)/ω))/Ne (7)

An energy spectrum of the characteristic X-ray has a peak characterized by materials composing the face plate.

Constituent elements of a phosphor used as a light emitting member include Zn, S, Al, Cu, Ag, Y, O, Eu, Ca, Si, N, Ga, Sr, etc. For example, a phosphor may be composed of P22 phosphors of three primary colors (blue: ZnS:Ag, green: ZnS:CuAl, and red: Y₂O₂SiO₂:Eu).

Electrons are caused to enter a face plate using various phosphor materials composed by combining the above-described elements.

In an energy spectrum of an X-ray emitted from the face plate, Al which is a material of the anode 13 has the largest contribution from a characteristic X-ray.

Measurement is performed on a face plate using various phosphor materials composed by combining the above-described elements. The relationship between δex and Va is substantially the same regardless of the location on the face plate where electrons enter. That is, the relationship between δex and Va is substantially the same regardless of phosphor materials.

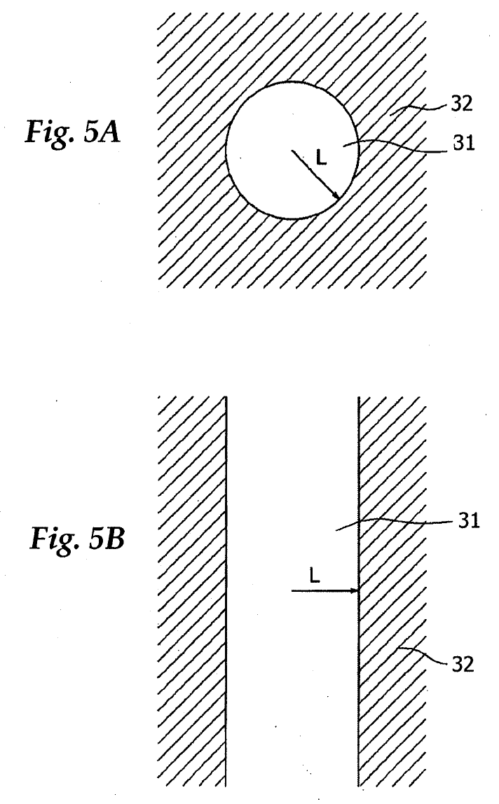

FIG. 6 is a diagram showing a relationship between the accelerating voltage Va of an electron beam and δex in this measurement. As shown in FIG. 6, δex is substantially proportional to the accelerating voltage Va of electrons entering the face plate.

As shown in FIG. 6,

δex=3.54×10⁻⁴, at Va=6 kV and

δex=5.90×10⁻⁴, at Va=10 kV.

Insulating members such as the insulating coat layer 3 and the insulating layers 2 shown in FIG. 1 practically use silicon oxide (typically, SiO₂) as a main component.

δxe is dependent on the incidnet angle of an X-ray onto an insulating surface. The δxe of the insulating surface can be found out as follows.

A photon beam having substantially the same energy spectrum as a photon beam produced from the face plate during the drive of the image display apparatus is irradiated onto a surface (insulating surface) of an insulating member having silicon oxide as a main component, to allow photoelectrons to be emitted from the insulating surface. The insulating member is deposited on an electron-supplying electrode for supplying electrons to the insulating member. In the vicinity of a surface of the insulating member is provided a photoelectron-capturing electrode having a positive potential with respect to the electron-supplying electrode. Photoelectrons emitted from the insulating surface are guided to the photoelectron-capturing electrode. Note that the film thickness of the insulating member is set to less than or equal to the range of electrons in the silicon oxide. By measuring the number of electrons supplied from the electron-supplying electrode relative to positive charges in the insulating member generated by the emission of photoelectrons, the number of photoelectrons generated per photon irradiated onto the insulating surface, i.e., δxe, is measured.

When the angle that the orientation of the insulating surface forms with an optical path of an X-ray entering the insulating surface is 0° (when an X-ray vertically enters the insulating surface), the δxe of the surface of the insulating member is 1×10⁻⁴.

When insulating members are subjected to an electron-emitting device manufacturing process and an image display apparatus manufacturing process, the sheet resistivity Rs of the insulating members is, as a practical range, preferably 1×10¹⁶ (Ω/□) or more and more preferably a value 1×10¹⁹ Ω/□ or more and 3×10²⁰ Ω/□ or less. Note that a material composing the insulating members in the present invention is not limited to silicon oxide.

Also, the sheet resistivity Rs of insulating surfaces in the present invention is not limited to 1×10¹⁹ Ω/□ or more and 3×10²⁰ Ω/□ or less. Rs can be any as long as Rs is one at which sufficient insulation for appropriately driving of image display apparatus is achieved between electrodes or between wirings or between an electrode and a wiring.

The sheet resistivity Rs of an insulating member can be measured, for example, as follows.

Specifically, a sample is obtained in which a pair of electrodes are disposed on a surface of an insulating member having been subjected to the same process as an image display apparatus manufacturing process, such that the surface is partially exposed at a spacing of several μm and a length of several tens of mm. Then, the sample is disposed in a vacuum container. Note that the spacing (a width overwhich the pair of electrodes face each other) and overall length of the pair of electrodes may have any value as long as the values are those at which a sheet resistivity Rs of 1×10¹⁹ Ω/□ or more and 3×10²⁰ Ω/□ or less can be measured. Then, the sample is heated in vacuum at 300° C. for 12 hours and moisture, etc., on the surface of the insulating member are removed. Thereafter, the sample is brought back to room temperature and potential differences from 0 V to 100 V are provided between the pair of electrodes and currents flowing between the pair of electrodes are measured with an ammeter that can measure at an accuracy of 0.1 pA.

The measurement is performed such that after providing a certain potential difference the potential difference is fixed for about several tens of minutes, and thereafter, a current value is read every several seconds for about several tens of minutes to several hours and then an average value of the read current values is obtained. By repeating this process every several V, a relationship between the potential difference and the current value can be obtained.

The above-described time in the measurement is required to obtain sufficient measurement accuracy; however, the time is dependent on a measurement system such as a vacuum container, a sample, and an ammeter. The above-described measurement is sensitive to external influences and thus is desirably performed under an environment where external influences are blocked as much as possible.

To verify the effects of the present invention, a test image display apparatus of the configuration shown in FIGS. 1 and 2 where 80×80 electron-emitting devices in row and column directions are disposed is configured, and all electron-emitting devices (80 electron-emitting devices) that are connected to any row are simultaneously driven.

The reason that 80 electron-emitting devices adjacent to each other in the row direction are simultaneously driven will be described below.

In a drive method for simultaneously driving 80 electron-emitting devices adjacent to each other in the row direction, X-rays from X-ray emitting points respectively for a plurality of electron-emitting devices are irradiated onto insulating surfaces in the respective electron-emitting devices. By this, comparing with a drive method for driving a single device, the amount of photoelectrons generated by the X-ray irradiation increases.

The amount of charge i per unit time and area by generation of photoelectrons caused by irradiation of an X-ray onto an insulating surface around a certain electron-emitting device is represented by the aforementioned equation (6).

In the example shown here, the sum (the right-hand side of equation (6)) is taken over all locations of X-ray emitting points for respective electron-emitting devices to be driven. In the drive of the aforementioned 80 electron-emitting devices, the sum is taken over all locations of X-ray emitting points for the respective 80 electron-emitting devices to be driven.

δex and Ie are quantities that are not dependent on a relationship between the location of an insulating surface of interest and the locations of X-ray emitting points for respective electron-emitting devices to be driven.

In the present example, when a plurality of electron-emitting devices have the same Va and Vf, the electron-emitting devices have substantially the same Ie. As described above, δex is substantially proportional to Va and is dependent on the composition of materials composing a portion of the face plate that is an incident location on the face plate of electrons emitted from each electron-emitting device. However, the composition of materials composing the face plate does not greatly vary among incident locations on the face plate of electrons emitted from the respective electron-emitting devices.

Also, in the present example, since the anode 13 is a single piece immediately above all the electron-emitting devices in the-image display apparatus, Va which is a potential difference between each electron-emitting device and the anode 13 is the same for all the electron-emitting devices. Therefore, in this case, Ie and δex are not substantially dependent on each individual electron-emitting device.

Accordingly, i in equation (6) can be rewritten as shown in the following equation (8):

i=(δex×Ie/(2×π))Σ(Φ×δxe) (8)

According to equation (8), i is proportional to δex and Ie. Also, as described above, δex is proportional to Va.

In a plurality of drive methods, when Va and Vf are constant, δex and Ie are constant. In this case, by Σ(Φ×δxe), a relative relationship of i of an insulating surface in an electron-emitting device of interest between various drive methods can be estimated. Specifically, by Σ(Φ×δxe), a relative relationship of i between a drive method for only a single electron-emitting device and a drive method for 80 electron-emitting devices or a relative relationship of i between the drive method for only a single electron-emitting device and a drive method for all electron-emitting devices in the image display apparatus can be found. Furthermore, a relative relationship of i between the drive method for only a single electron-emitting device and a drive method for an image display apparatus having a plurality of electron-emitting devices disposed at various spacings can be obtained.

Now, the case will be considered in which Va and Vf are identical in all of a plurality of drive methods.

In Σ(Φ×δxe), δxe approximately follows the following equation (9):

δxe˜R/(4×μ×cos θ) (9)

In equation (9), R is the range of electrons, μ is the X-ray attenuation length, and θ is the angle that the direction of an insulating surface forms with an X-ray optical path.

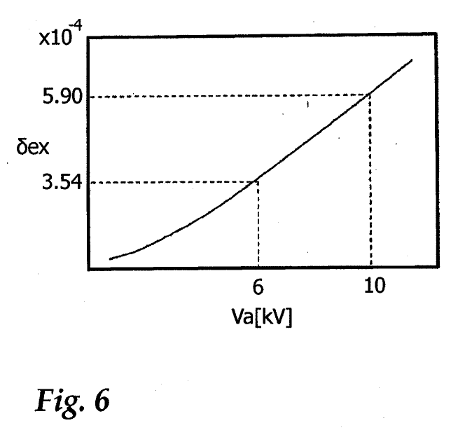

FIGS. 7A and 7B are diagrams for describing the above equation. FIG. 7A shows the case in which an X-ray vertically enters the insulating surface (i.e., θ=0) and FIG. 7B shows the case in which an X-ray obliquely enters the insulating surface. The term “μ×cos θ” in equation (9) corresponds to an X-ray attenuation length in a direction vertical to the insulating surface.

On the other hand, a solid angle Φ per unit area on an insulating surface in each device from an X-ray emitting point follows equation (10) shown below.

Φ=(cos θ/r²) (10)

In equation (10), r is the distance between an X-ray produced location and the insulating surface.

Since R and μ are dependent on a material of an insulating surface, when the physical properties of insulating surfaces in the respective electron-emitting devices of the image display apparatus are substantially the same, R and μ are not dependent on the electron-emitting devices. Accordingly, Σ(Φ×δxe) is proportional to Σ1/r².

When the distance between an insulating surface in an electron-emitting device of interest and an X-ray emitting point for an electron-emitting device to be driven is farther, contribution is reduced by 1/r².

In a rear plate fabricated in an example described here, a spacing between adjacent electron-emitting devices in the row direction is 205 μm. A gap between a face plate and the electron-emitting devices (insulating surfaces) is 1.6 mm.

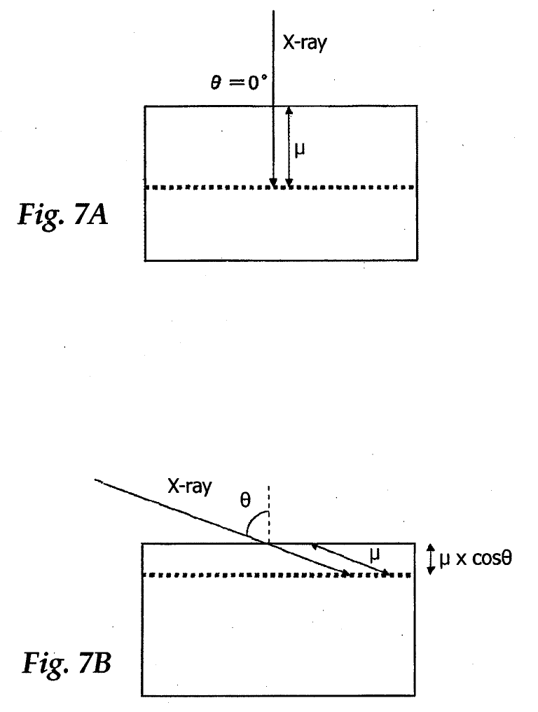

FIG. 8 is a diagram showing the ratio of the amount of charge i per unit area and time due to generation of photoelectrons on an insulating surface between when 80 electron-emitting devices arranged in the row direction are simultaneously driven and when only a single electron-emitting device is driven, for the 80 electron-emitting devices.

As shown in FIG. 8, of the 80 electron-emitting devices, in an electron-emitting device at the center, contribution of X-ray irradiation from an X-ray emitting point with a short r is large and an X-ray is most irradiated, and thus, the ratio of i is highest.

The amount of charge per unit area and time by generation of photoelectrons on an insulating surface around an electron-emitting device, during drive by a drive method for driving only a single electron-emitting device will be denoted by i_{1d}. The maximum value of the amount of charge i per unit area and time by generation of photoelectrons, during the drive of 80 electron-emitting devices arranged in the row direction will be denoted by i_{80d}. The ratio of i_{80d} to i_{1d} (i_{80d}/i_{1d}) is

$$\begin{matrix}( {i}_{80 d} / {i}_{1 d} ) = ( \sum ( 1 / {r}^{2} ) ) / ( 1 / {r}^{2} ) \\ = ( 1 / ( {1600}^{2} ) + 2 / {205}^{2} + {1600}^{2} ) + \\ 2 / ( {( 2 \times 205 )}^{2} + {1600}^{2} ) + \\ 2 / ( {( 3 \times 205 )}^{2} + {1600}^{2} ) + … + 2 / ( {( 39 \times 205 )}^{2} + {1600}^{2} ) + \\ 1 / ( {( 40 \times 205 )}^{2} + {1600}^{2} ) ) / ( 1 / ( {1600}^{2} ) ) \\ \approx 21.5\end{matrix}$$

In a 55-inch size image display apparatus, 1920 pixels in total are arranged in the row direction, each pixel including three electron-emitting devices, and 1080 of such a row are arranged in the column direction. In such a configuration, the case will be considered in which a spacing between the electron-emitting devices in the row direction is 205 μm, a spacing between the electron-emitting devices in the column direction is 615 μm, and a gap between a face plate and the electron-emitting devices is 1.6 mm.

The case will be considered in which in the 55-inch size image display apparatus all the electron-emitting devices are driven. In this case, X-rays from X-ray emitting points respectively for all the electron-emitting devices are irradiated onto insulating surfaces in the respective electron-emitting devices. The maximum value of the amount of charge i per unit area and time by generation of photoelectrons on the insulating surfaces will be denoted by i₅₅ᵢₙ.

At this time, i₅₅ᵢₙ is provided at an insulating surface around an electron-emitting device located at the center among the electron-emitting devices arranged in a matrix of 5760×1080 in the row and column directions, unless all the X-rays from the X-ray emitting points are shielded. At this time, the value of (i₅₅ᵢₙ/i_{1d}) is obtained as follows by computing the sum of all disposed electron-emitting devices for not only the row direction but also the column direction in the same manner as that described above.

$$\begin{matrix}( {i}_{55 in} / {i}_{1 d} ) = ( \sum ( 1 / {r}^{2} ) ) / ( 1 / {r}^{2} ) \\ = \{ 1 / ( {1600}^{2} ) + \\ 2 / ( {205}^{2} + {1600}^{2} ) + \\ 2 / ( {( 2 \times 205 )}^{2} + {1600}^{2} ) + \\ … + \\ 2 / ( {( 5759 \times 205 )}^{2} + {1600}^{2} ) + \\ 1 / ( {( 5760 \times 205 )}^{2} + {1600}^{2} ) + \\ 2 [ 1 / ( {615}^{2} + {1600}^{2} ) + \\ 2 / ( {205}^{2} + {615}^{2} + {1600}^{2} ) + \\ 2 / ( {( 2 \times 205 )}^{2} + {615}^{2} + {1600}^{2} ) + \\ … + \\ 2 / ( {( 5759 \times 205 )}^{2} + {615}^{2} + {1600}^{2} ) + \\ 1 / ( {( 5760 \times 205 )}^{2} + {615}^{2} + {1600}^{2} ) ] + \\ 2 [ 1 / ( {( 2 \times 615 )}^{2} + {1600}^{2} ) + \\ 2 / ( {205}^{2} + {( 2 \times 615 )}^{2} + {1600}^{2} ) + \\ 2 / ( {( 2 \times 205 )}^{2} + {( 2 \times 615 )}^{2} + {1600}^{2} ) + \\ … + \\ 2 / ( {( 5759 \times 205 )}^{2} + {( 2 \times 615 )}^{2} + {1600}^{2} ) + \\ 1 / ( {( 5760 \times 205 )}^{2} + {( 2 \times 615 )}^{2} + {1600}^{2} ) ] + \\ … + \\ 2 [ 1 / ( {( 539 \times 615 )}^{2} + {1600}^{2} ) + \\ 2 / ( {205}^{2} + {( 539 \times 615 )}^{2} + {1600}^{2} ) + \\ 2 / ( {( 2 \times 205 )}^{2} + {( 539 \times 615 )}^{2} + {1600}^{2} ) + \\ … + \\ 2 / ( {( 5759 \times 205 )}^{2} + {( 539 \times 615 )}^{2} + {1600}^{2} ) + \\ 1 / ( {( 5760 \times 205 )}^{2} + {( 539 \times 615 )}^{2} + {1600}^{2} ) ] + \\ 1 / ( {( 540 \times 615 )}^{2} + {1600}^{2} ) + \\ 2 / ( {205}^{2} + {( 540 \times 615 )}^{2} + {1600}^{2} ) + \\ 2 / ( {( 2 \times 205 )}^{2} + {( 540 \times 615 )}^{2} + {1600}^{2} ) + \\ … + \\ 2 / ( {( 5759 \times 205 )}^{2} + {( 540 \times 615 )}^{2} + {1600}^{2} ) + \\ 1 / ( {( 5760 \times 205 )}^{2} + {( 540 \times 615 )}^{2} + {1600}^{2} ) \} / \\ ( 1 / ( {1600}^{2} ) ) \\ \approx 748\end{matrix}$$

That is, (i₅₅ᵢₙ/i_{1d}) takes the following value:

(i₅₅ᵢₙ/i_{1d})≈748

However, in an actual image display apparatus, the inside of the image display apparatus is maintained at high vacuum. Therefore, due to the difference in pressure between the outside and inside of the image display apparatus, there is a possibility that a rear plate and a face plate may be deformed or broken. To prevent this, spacers may be provided between the rear plate and the face plate. Now, the case will be considered in which in the above-described 55-inch size image display apparatus spacers having a shape (plate-like) extending end to end in the row direction are disposed in the column direction on row-direction wirings every 30 rows.

When an X-ray having an energy of 10 keV is irradiated onto the spacer, the attenuation length in the spacer of the X-ray is 300 μm or less. When an electron-emitting device is driven at Va=10 kV, electrons having an energy of the order of 10 keV enter the face plate. At that time, a characteristic X-ray corresponding to the composition of materials composing a region of the face plate having energy of 10 keV or less is emitted. The characteristic X-ray includes a characteristic X-ray from the composition of materials (e.g., an anode, a phosphor, and a getter) at an area of the face plate where the electrons enter. However, as described previously, in the spectrum of an X-ray emitted from the face plate, contribution from a characteristic X-ray of Al which is a constituent material of the anode is largest.

When the thickness in the column direction of the spacers is 300 μm, i.e., when the thickness is thicker than the X-ray attenuation length, the X-rays cannot reach insulating surfaces through the spacers. Thus, when a spacer is disposed between the location of an insulating surface in an electron-emitting device of interest and the location of a corresponding X-ray emitting point, in the sum in the above equation, the X-ray emitting point needs to be excluded from the sum. When spacers are disposed in the 55-inch size image display apparatus, taking into account the above, i₅₅ᵢₙ is provided at an insulating surface around an electron-emitting device at the center among a plurality of electron-emitting devices arranged in a matrix of 5760×30 in the row and column directions. The value of (i₅₅ᵢₙ/i_{1d}) is as follows.

(i₅₅ᵢₙ/i_{1d})≈317

This indicates that generation of photoelectrons is reduced by the presence of the spacers. Namely, it indicates that an increase in potential caused by irradiation of X-rays onto insulating surfaces in electron-emitting devices can be controlled depending on how the spacers are disposed.

However, in the drive of 80 electron-emitting devices arranged in the row direction in the above-described test image display apparatus, since plate-like spacers are disposed extending in the row direction, shielding from X-rays by the spacers is not provided between the 80 devices. Accordingly, there is no reduction in the above-described (i_{80d}/i_{1d}) by the presence of the spacers.

In an actual image display apparatus, wirings, etc., disposed on a rear plate may have a height of the order of several μm to several tens of μm and they may block optical paths between X-ray emitting points and insulating surfaces. In this case, an optical path of an X-ray from an X-ray emitting point farther away from an insulating surface of interest is more likely to be blocked. This indicates that generation of photoelectrons is reduced by the structures on the rear plate. That is, it indicates that an increase in potential caused by irradiation of X-rays onto insulating surfaces in electron-emitting devices can be controlled depending on how the structures on the rear plate are disposed. The same can also be said for structures on a face plate. Furthermore, the same can also be said for electrodes for mainly controlling the trajectories of electrons or a third substrate including the electrodes, which are disposed between the face plate and the rear plate.

When an image display apparatus including electron-emitting devices arranged in a matrix (rows and columns) is driven, a predetermined voltage is applied to one of a plurality of row-direction wirings and a column-direction wiring connected to an electron-emitting device to be driven among a plurality of electron-emitting devices connected to the row-direction wiring. By sequentially performing this operation on all the row-direction wirings, one image is displayed. Then, by repeating this operation, a moving image can be displayed. A drive method in which the row-direction wirings are sequentially selected in the above-descried manner is called scroll drive. One cycle (i.e., one frame) of scroll drive refers to the time taken from the start of drive of a certain row (typically, a row located topmost) until drive of all the rows (typically, a row located bottommost) is completed.

In each electron-emitting device, by applying a voltage Vf exceeding a voltage (threshold voltage) required to start electron emission, between a negative electrode (cathode) and a positive electrode (gate) composing the electron-emitting device, electrons are emitted.

Now, the maximum value of i at certain Va and Vf in scroll drive of the 55-inch size image display apparatus is determined. For that, the case will be considered in which when a voltage is applied to a certain row-direction wiring a voltage Vf is applied between a negative electrode and a positive electrode of each of all electron-emitting devices connected to the row-direction wiring.

That is, the case will be considered in which when, during scroll drive, a voltage is applied to a certain row-direction wiring, all electron-emitting devices connected to the row-direction wiring are driven by Vf. At this time, the case will be considered in which the waveform of a voltage applied between a negative electrode and a positive electrode of each electron-emitting device is a rectangular wave. At this time, the maximum value of a voltage applied to each electron-emitting device is Vf and the minimum value is a voltage applied to a column-direction wiring.

The ratio of a period (selected period) during which Vf is applied and electrons are emitted from one electron-emitting device to one cycle (one frame) in a periodic rectangular wave is called a duty cycle.

For methods of controlling the amounts of electrons emitted from respective electron-emitting devices, there are a method of controlling by varying Vf, a method of controlling by varying the time during which Vf is applied in a rectangular wave with Vf being fixed, i.e., a method of controlling by varying the duty cycle, and a method that uses these two methods in combination.

When Vf is fixed, the maximum value of the amount of charge per unit area and time by generation of photoelectrons on insulating surfaces in electron-emitting devices composing the image display apparatus is obtained when the time during which Vf is applied in each electron-emitting device is increased as much as possible.

When the 55-inch size image display apparatus is scroll-driven, in drive where the time during which Vf is applied in each electron-emitting device is longest, the ratio of the time during which Vf is applied to one cycle of scroll drive is one to the number of rows, i.e., a ratio of 1 to 1080. That is, in this case, the duty cycle is 1/1080. In this drive, all electron-emitting devices in any row in the image display apparatus are always driven by Vf at every moment. This drive corresponds to the case of driving all pixels at the highest possible brightness at certain Va and Vf in the image display apparatus.

The time average of i for a drive method for simultaneously driving all electron-emitting devices (80 electron-emitting devices) connected to any row in the aforementioned test image display apparatus, for showing effects of the present example is compared with the time average of i for the above-described drive of the 55-inch size image display apparatus.

In this case, Va, Ie, and the duty cycle need to be taken into account.

The time average of i is given by equation (11) shown below.

Time average of i=(δex×Ie×D/(2×π))Σ(Φ×δxe) (11)

The D in the above equation (11) is the duty cycle. As described previously, δex is substantially proportional to Va. The case will be considered in which in the 55-inch size image display apparatus 10 kV is applied as an anode voltage Va, Ie of each electron-emitting device is 4.5 μA, and all electron-emitting devices in one row are scroll-driven at a duty cycle of 1/1080. The ratio of the above-described drive to the drive of one electron-emitting device in Σ(Φ×δxe) is, as described above, about 317.

In the above-described test image display apparatus, 6 kV is applied as Va. In that case, Ie for when Vf is applied is 2.3 μA. Furthermore, the duty cycle is 1/10. The ratio of the above-described drive to the drive of one electron-emitting device in Σ(Φ×δxe) is, as described above, about 21.5.

When the time average of i for the test image display apparatus is iₐᵥ and the time average of i for the 55-inch size image display apparatus is iₐᵥ₅₅ᵢₙ, the ratio of iₐᵥ to iₐᵥ₅₅ᵢₙ (iₐᵥ/iₐᵥ₅₅ᵢₙ) is as follows:

(iₐᵥ/iₐᵥ₅₅ᵢₙ)≈(6/10)×(2.3/4.5)×((1/10)/(1/1080))×(21.5/317)≈2.25

That is, an amount of charge that is more than twice as large as the maximum value of the amount of charge per unit area and time on insulating surfaces obtained when all pixels are driven at maximum brightness in the 55-inch apparatus can be brought about in the drive of 80 devices in the test image display apparatus.

In the drive of an actual image display apparatus, driving of all pixels at maximum brightness for the entire drive time does not occur and each electron-emitting device is driven at a brightness that is moderately suppressed to display a desired image. Thus, the actual amount of charge per unit area and time by generation of photoelectrons is considered to be mostly much smaller than the above-described iₐᵥ₅₅ᵢₙ and the actual (iₐᵥ/iₐᵥ₅₅ᵢₙ) is considered to be larger than the above-described value. Hence, the drive of 80 electron-emitting devices of the test image display apparatus that obtains the above-described iₐᵥ can be said to be a drive method in which an increase in the potential of an insulating surface caused by irradiation of an X-ray onto the insulating surface is tested under a much stricter environment than that in actual cases.

In view of the future of image display apparatuses, development of FEDs with higher definition is expected.

When FEDs have higher definition, the number of electron-emitting devices per unit area disposed on a rear plate becomes larger. In that case, Σ(Φ×δxe) becomes larger. In that case, Ie and Va that are required to obtain excellent display characteristics may be suppressed to low levels, depending on the phosphor material. However, it is expected that when Ie, Va, D, and δex are fixed, i is increased by an amount corresponding to the increase in Σ(Φ×δxe). Because there is such an expectation, it is desirable to check whether there is deterioration in electron-emitting devices or abnormality in display characteristics, under a strict condition where the potentials of insulating surfaces more easily increase, which is a condition where i obtained in the drive of the test image display apparatus is made larger.

An anode voltage Va=6 kV is applied between an electrode 6 and the anode 13 and an amplitude (drive voltage) Vf=16.8 V of a rectangular wave with a cycle T=10 ms and a voltage application time P=1 ms is applied between the electrode 6 and an electrode 5. This rectangular wave is called a pulse. When one cycle of the rectangular wave is input to an electron-emitting device, it is expressed such that “one pulse is input”. A current generated by electrons emitted from a spacing 8 during drive will be denoted by If and a current generated by some of the electrons that flow through the anode 13 will be denoted by Ie. At this time, efficiency η is represented by the following equation:

η=Ie/If

A potential distribution of an insulating surface with a sheet resistivity Rs caused by charge being generated on the insulating surface affects a potential distribution in space in the image display apparatus and an electron trajectory determined thereby. Also, the electron trajectory affects η and η changes by the maximum potential V of potentials of the insulating surface.

In the above-described test image display apparatus, electron-emitting devices having L1 shown in FIG. 1=10 μm, 15 μm, 20 μm, 40 μm, and 57.5 μm are fabricated.

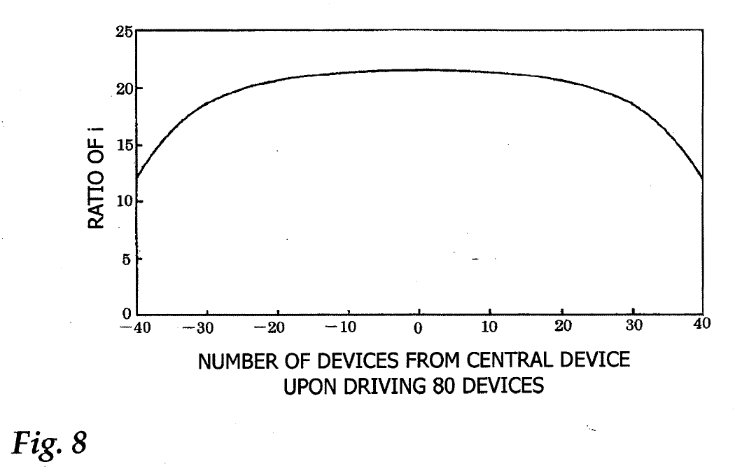

FIG. 9 is a diagram showing a relationship between (η-ηᵥ₌₀)/ηᵥ₌₀ and V obtained by electron trajectory calculation. The electron trajectory calculation is performed in the case in which under a model of an equivalent drive of the above-described test image display apparatus, i is uniformly provided to each point on an insulating surface with a sheet resistivity Rs. That is, a potential distribution by a current distribution on a surface which is formed in the above-described case, a potential distribution in space in the apparatus using the potential distribution by a current distribution on a surface as a boundary condition, and trajectories of electrons emitted from an electron-emitting portion in the potential distribution in space are calculated.

FIG. 9 shows calculation results for the respective electron-emitting devices having L1=10 μm, 15 μm, 20 μm, 40 μm, and 57.5 μm. In FIG. 9, ηᵥ₌₀ indicates η for when V=0. Thus, the vertical axis (η-ηᵥ₌₀)/ηᵥ₌₀ indicates the rate of change of η with respect to V. This is called the rate of change in efficiency.

For a method of measuring a potential of an insulating surface in the image display apparatus during drive, a method can be used in which η is determined by measuring Ie and If and the potential V of the insulating surface is derived from the relationship between η and V shown in FIG. 9.

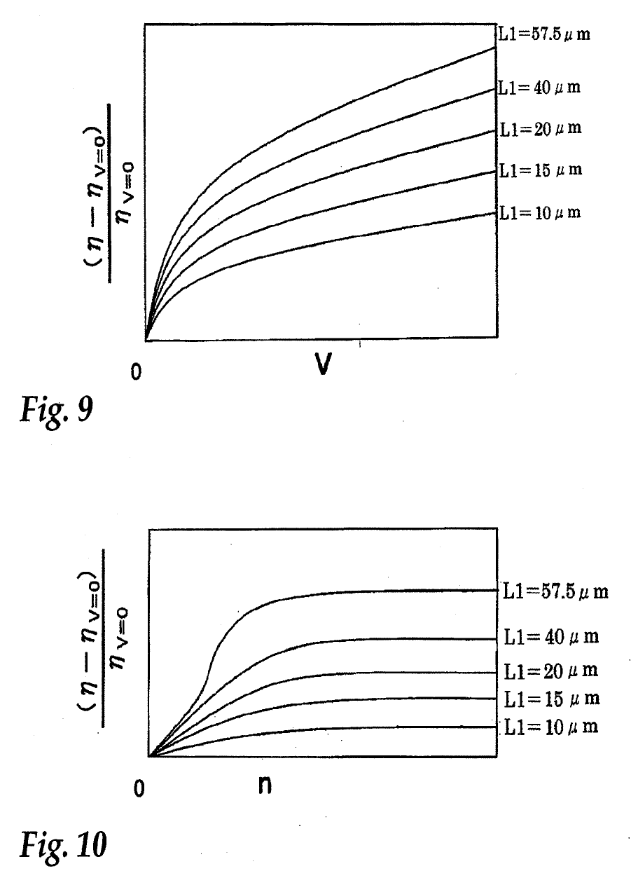

FIG. 10 is a diagram showing measurement results of the behavior of η for when the test image display apparatus is driven. FIG. 10 shows measurement results for the respective electron-emitting devices having L1=10 μm, 15 μm, 20 μm, 40 μm, and 57.5 μm.

In FIG. 10, n is the number of input pulses of a rectangular wave having a potential difference Vf applied between an electrode (positive electrode) 5 and an electrode (negative electrode) 6 of an electron-emitting device, i.e., the number of pulses. FIG. 10 shows conditions where (η-ηᵥ₌₀)/ηᵥ₌₀ increases with an increase in n, i.e., an increase in the number of pulses.

If and Ie are measured by inputting pulses and driving the electron-emitting device.

Ie at n=1, i.e., the first input pulse, is about 2.3 μA and If is about 0.6 mA. Almost the same results as those are obtained for all of a plurality of electron-emitting devices.

When n=1000, i.e., when the number of input pulses is 1000, (η-ηᵥ₌₀)/ηᵥ₌₀ is 0.3 for the electron-emitting device having L1=57.5 μm and (η-ηᵥ₌₀)/ηᵥ₌₀ is 0.05 for the electron-emitting device having L1=10 μm.

At (η-ηᵥ₌₀)/ηᵥ₌₀ for when n>1000, there is almost no change from (η-ηᵥ₌₀ )/ηᵥ₌₀ obtained when n=1000 in the electron-emitting devices of any L1.

When the results of the electron trajectory calculation shown in FIG. 9 are used, the maximum potential V of an insulating surface at n≧1000 in FIG. 10 is V for the electron-emitting device having L1=57.5 μ,
230 V for the electron-emitting device having L1=40 μm,
65 V for the electron-emitting device having L1=20 μm,
35 V for the electron-emitting device having L1=15 μm, and
30 V for the electron-emitting device having L1=10 μm.

Although when L1 increases, the potential of an insulating surface increases, such a level of discharge that deteriorates an electron-emitting device does not occur in 24-hour drive in any of the above-described electron-emitting devices.

However, as described above, when the potential difference ΔV between a negative electrode and an insulating surface exceeds ΔV=V_{E1}, by secondary electron emission caused by electrons entering the insulating surface, the potential difference between the negative electrode and the insulating surface increases to ΔV=V_{E2}. However, this is a conclusion obtained when the electrons entering the insulating surface are exclusively considered to be only emitted electrons from the negative electrode. In practice, the electrons entering the insulating surface may also include secondary electrons emitted from the insulating surface. The energy of secondary electrons at the point in time when the secondary electrons are emitted from the insulating surface is several eV.

A conductive member is present around an insulating surface and depending on the potential of the conductive member, an electric field distribution formed by an increase in the potential of the insulating surface may encourage secondary electrons emitted from the insulating surface to get back to the insulating surface, even if a voltage Va is applied to the anode. In this case, the energy of secondary electrons emitted from a certain location on the insulating surface and entering a certain location on the insulating surface, upon the entrance may be extremely small depending on a potential distribution on the insulating surface and a relationship between the emitting location and the entering location.

In that case, a secondary electron emission coefficient by secondary electrons entering the insulating surface is less than one. Accordingly, the secondary electrons entering the insulating surface act to reduce the potential of the insulating surface, by generating negative charge on the insulating surface.

Such an effect of reducing the potential of an insulating surface is considered to act so that a potential difference between an insulating surface and an electrode or between an insulating surface and a wiring is not increased to such a level that causes a discharge.

In practice, when, upon application of an anode voltage Va, the potential V of an insulating surface is higher than a potential for driving an electron-emitting device which is applied to a conductive member disposed around the insulating surface, a valley appears in a potential distribution between the insulating surface and the anode. By this, an electric field distribution where secondary electrons emitted from the insulating surface easily get back to the insulating surface is obtained. Furthermore, the electric field distribution is one where the higher the potential V of the insulating surface the easier it is for secondary electrons to get back to the insulating surface.

This indicates that by appropriately selecting a relative relationship between a potential for driving an electron-emitting device which is applied to a conductive member disposed around an insulating surface and the potential of the insulating surface and the potential of the anode, the direction in which secondary electrons emitted from the insulating surface travel can be controlled.

Summarizing the above findings, in a potential region of an insulating surface where the secondary electron emission coefficient of electrons entering the insulating surface from a negative electrode is one or more, when the potential of the insulating surface is relatively low, secondary electrons emitted from the insulating surface travel toward the anode without being trapped in the insulating surface. That is, this is a region where the potential difference AV between the negative electrode and the insulating surface is ΔV>V_{E1}. As a result, positive charge remains on the insulating surface, acting to increase the potential of the insulating surface. However, when the increase in the potential of the insulating surface proceeds, an electric field distribution where secondary electrons emitted from the insulating surface are trapped in the insulating surface is formed in space in the vicinity of the insulating surface. As a result, secondary electrons get back to the insulating surface and cancel out the positive charge on the insulating surface and thereby act to reduce the potential of the insulating surface.

It is considered that a potential change that involves the increase and decrease of the potential caused by secondary electron emission occurs in the above-described manner in the vicinity of a potential that is determined by an increase in potential caused by an X-ray.

The presence of such a potential change involving the increase and decrease of the potential caused by secondary electron emission may become a factor in making the drive of an electron-emitting device unstable and thus is not desirable even if, as described above, a potential change involving the increase and decrease of the potential caused by secondary electron emission occurs in the vicinity of a potential determined by an increase in potential caused by an X-ray and thus even when the potential is continuously increased such a level of discharge that deteriorates the electron-emitting device does not occur.

Accordingly, it is desirable that the increase in the potential V of the insulating surface caused by an X-ray be suppressed to a level lower than the potential difference AV between the negative electrode and the insulating surface=V_{E1}.

As described above, the insulating coat layer 3 preferably has SiO₂ as a main component. E1 of SiO₂ at V_{E1} is 44 eV according to Dionne. In the drive of the above-described test image display apparatus, −8.4 V is applied to a negative electrode. Assuming that at the point in time when electrons are emitted from the potential of the negative electrode the energy of the electrons is zero, in order that the electrons have an energy of E1=44 eV when reaching an insulating surface, the potential V of the insulating surface is

44[V]−8.4[V]=35.6[V].

Accordingly, in order that ΔV<V_{E1}, V needs to be such that V<35.6 [V].

In the drive of the above-described test image display apparatus, in electron-emitting devices having L1 of 15 μm or less, the potential of an insulating surface is suppressed to 35 V. Thus, ΔV<V_{E1} is satisfied and accordingly, as an image display apparatus in the present invention, L1 in the test image display apparatus is most desirably such that L1≦15 μm.

However, in 24-hour drive, such a high level of discharge that actually deteriorates an electron-emitting device does not occur in the electron-emitting devices of any L1 in the test image display apparatus. Hence, considering the point of view of such an experimental fact, there is a fair chance that electron-emitting devices having L1>15 μm can also be put to practical use.

Meanwhile, in the device having L1=57.5 μm in the test image display apparatus, it is found that η is changed by the order of 30% from the initial η, and moreover, as shown in FIG. 10, in the process of an increase in η, sudden acceleration in the increase in η is observed that is not observed in any of electron-emitting devices having L1=40 μm or less.

When electron-emitting devices are used in an image display apparatus, such sudden acceleration in the increase in η causes sudden acceleration in brightness, which may cause visual discomfort. Thus, even if such a level of discharge that deteriorates an electron-emitting device does not occur, such sudden acceleration in the increase in η is not practically desirable. Hence, the electron-emitting device having L1=57.5 μm in the test image display apparatus is not desirable as an image display apparatus in the present invention.

Accordingly, as an image display apparatus in the present invention, it is desirable that L1≦40 μm in the test image display apparatus.

The relationship between L1 and V for when n≧1000 shown in FIG. 10 in drive using the test image display apparatus substantially follows the following relational expression which is the above-described relationship between L and V for the shape of an insulating surface shown in FIG. 5B.

V=(Rs×i×L²)/2

L=L1/2

Here, i in the above equation is the time average of i shown in the following equation.

The time average of i

$$\begin{matrix}= ( δ ex \times Ie \times D / ( 2 \times π ) ) \sum ( Φ \times δ xe ) \\ = ( δ ex \times Ie \times D / ( 2 \times π ) ) ( {i}_{80 d} / {i}_{1 d} ) {( Ω \times δ xe )}_{1 d} \\ \approx 1.1 \times {10}^{- 20} [ A / {µm}^{2} ]\end{matrix}$$

The time average of i is, as described above, considered to be very large as compared with the time average of i obtained in the drive of an actual image display apparatus. Thus, it can be said that this is a situation in which an increase in the potential of an insulating surface by irradiation of an X-ray onto the insulating surface more easily takes place.

Respective physical quantities in the above equation take the aforementioned values for the test image display apparatus.

The (Φ×δxe)_{1d} in the above equation is the product of Φ and δxe on an insulating surface in an electron-emitting device obtained in the drive of the electron-emitting device.

Φ in (Φ×δxe)_{1d} has the following value based on the fact that the distance between the rear plate and the face plate is 1.6 mm.

Φ=cos(0)/r²≈3.91×10⁻⁷[sr/μm²]

The δxe in (Φ×δxe)_{1d} is δxe for when the angle that the orientation of the insulating surface forms with an optical path of an X-ray entering the insulating surface is 0°, and has the following value as described above.

δxe=1×10⁻⁴

Since Va=6 kV,

δxe=3.54×10⁻⁴,

D=1/10,

Ie=2.3 μA,

(i_{80d}/i_{1d})≈21.5, and

Rs is between 1×10¹⁹ Ω/□ and 3×10^{20 Ω/□.}

The above fact indicates that the main factor in the increase in the potential of the insulating surface that determines the relationship between L1 and V for when n≧1000 shown in FIG. 10 is the increase in potential caused by an X-ray.

As described above, it is desirable that the potential difference ΔV between the negative electrode and the insulating surface be suppressed to a level lower than V_{E1}. Hence, when the potential of the negative electrode is Vₙₑ, it is desirable that Rs, i, and L be determined to satisfy

(Rs×i×L²)/2−Vₙₑ<V_{E1}.

As described above, for the magnitude relationship between L1 and L3 in FIG. 1 in the test image display apparatus, L3 is more than 10 times larger than L1. Hence, since a potential formed during drive with the shape of an insulating surface in the test image display apparatus is considered to be approximately the same as a potential formed during drive with the shape shown in FIG. 5B, the above equation is used to represent results of the drive of the test image display apparatus.

As described above, on an insulating surface of an arbitrary shape, V follows the following equation.

(Rs×i×L²)/4≦V≦(Rs×i×L²)/2

On an insulating surface of an arbitrary shape, the lowest V is obtained with a circular insulating surface such as that shown in FIG. 5A and the highest V is obtained with an insulating surface of a shape such as that shown in FIG. 5B, and by that, the upper and lower limits to V in the above equation are determined.

Thus, in order that on an insulating surface of an arbitrary shape the potential difference between the negative electrode and the insulating surface is ΔV<V_{E1}, it is most desirable that Rs, i, and L be those that establish

(Rs×i×L²)/2−Vₙₑ<V_{E1}

but depending on the shape of the insulating surface, conditions imposed on Rs, i, and L are loosened. The shape of a circular insulating surface has the loosest conditions and Rs, i, and L are allowed to take values that establish

(Rs×i×L²)/4−Vₙₑ<V_{E1}.

The following equation having the strictest conditions will be considered below.

(Rs×i×L²)/2−Vₙₑ<V_{E1}.

The i in the above equation, i.e., the amount of charge per unit area and time caused by generation of photoelectrons on an insulating surface in an electron-emitting device, includes physical quantities that are not dependent on the shape or material of the insulating surface, such as Ie, δex, and the duty cycle D, excluding δxe. Those physical quantities are dependent on Va which is required to obtain excellent display characteristics in the image display apparatus, materials composing the face plate, and a drive method, and are not dependent on the shape or material of the insulating surface. Thus, when the shape of an insulating surface is determined to obtain excellent display characteristics, i is fixed.

The case will be considered in which i is a value obtained in the drive of 80 electron-emitting devices of the test image display apparatus. This i, as described above, exceeds i obtained in the drive of all pixels at maximum brightness in an actual 55-inch size image display apparatus and thus the potential more easily increases on the insulating surface. Thus, when the shape of an insulating surface is determined using this i, in the above equation, a condition imposed on L when the resistivity of the insulating surface is Rs is stricter than that for actual cases.

Considering the case in which a material of the insulating surface is SiO₂, E1=44 eV is considered. The above-described value is the highest value for an entrance angle of entered electrons onto the insulating surface and, in practice, entered electrons with various entrance angles are considered to be present. The voltage applied to a negative electrode may range from the order of minus several V to minus several tens of V.

Taking into account the above points, it is appropriate to rewrite the above equation approximately as follows.

(Rs×i×L²)/2<10 [V]

At this time, when the time average of i=1.1×10⁻²⁰ [A/μm²]

Rs×L²<1.8×10²¹ [Ω×μm²]

In the case in which the sheet resistivity of an insulating surface in an electron-emitting device is Rs, when the shape of the insulating surface is determined by L in the above equation, an increase in the potential of the insulating surface caused by irradiation of an X-ray onto the insulating surface is suppressed to a level lower than V_{E1}, by movement of charge on the insulating surface. Accordingly, by determining the shape of an insulating surface in an electron-emitting device by L such as that in the above equation, an increase in the potential of the insulating surface can be suppressed and a discharge that deteriorates the electron-emitting device can be inhibited, without depositing a resistive film, etc., on the insulating surface.

However, as described above, in the drive of 80 electron-emitting devices of the test image display apparatus, even in the electron-emitting device having L1=40 μm, such a level of discharge that deteriorates the electron-emitting device does not occur and thus the electron-emitting device may be able to be practically used as an image display apparatus. The potential of an insulating surface in the electron-emitting device having L1=40 μm is, as described above, increased to 230 V in the drive of 80 electron-emitting devices of the test image display apparatus. Thus, it can be said that it is experimentally shown that electron-emitting devices having insulating surfaces with a potential of 230 V or less may be able to be practically used as an image display apparatus.

At this time, restrictions imposed on L with respect to Rs in the above equation are loosened as shown in the following equation.

(Rs×i×L²)/2<230 [V]

At this time, when the time average of i=1.1×10⁻²⁰ [A/μm² ],

Rs×L²<4.2×10²²[Ω×μm²]

Note that the definition of L is so far the maximum value in a set of the shortest distances between all points on an insulating surface and a conductive member. For those points on the insulating surface other than a point on the insulating surface that corresponds to the maximum value, the shortest distances between the points and the conductive member are smaller than L. Thus, when L is redefined as the shortest distance between an arbitrary point on the insulating surface and the conductive member, the above equation is established for all the points on the insulating surface. Accordingly, when, for simplicity, L is redefined as the shortest distance connecting a point on the insulating surface and the conductive member, a condition that all the points on the insulating surface satisfy the above equation is added.

### Implemental Examples

### First Implemental Example

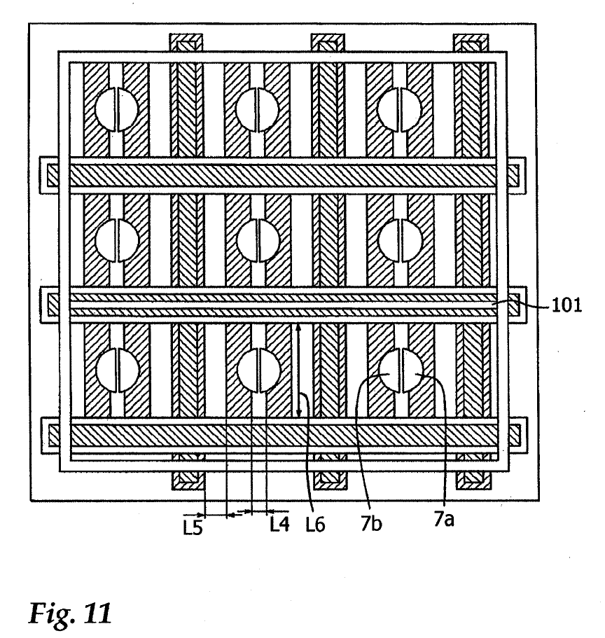

In this example, an image display apparatus is fabricated by combining a rear plate whose schematic plan view is shown in FIG. 11 and a faceplate of an image display apparatus shown in FIG. 2.

In FIG. 11, reference numeral 101 denotes a spacer and the same members as those in FIG. 1 are denoted by the same reference numerals. Note that although in FIG. 11, for convenience of description, a matrix of three rows and three columns is shown, in practice, electron-emitting devices are disposed in a matrix of 5760 rows and 1080 columns. Also, spacers 101 have a shape extending end to end in a row direction of the matrix and are disposed on row-direction wirings 1 in the first, 31st, 61st, 91st, . . . , 1021st, 1051st, and 1080th rows. Spacings between the electron-emitting devices are 615 μm in a column direction and 205 μm in the row direction.

In the present example, an insulating coat layer 3 is composed of SiO₂ and has a sheet resistivity Rs of about 4×10¹⁹(Ω/□). A substrate 12 of the face plate is a glass with a thickness of 2.8 mm. An anode 13 is composed of Al.

Phosphors 14 are composed of P22 phosphors of three primary colors (blue: ZnS:Ag, green: ZnS:CuAl, and red: Y₂O₂SiO₂:Eu). A light-shielding layer 15 is a black matrix composed of a black resin material containing carbon. A getter 16 is composed of Ti and Ba.

The distance between the face plate and the rear plate is 1.6 mm.

The image display apparatus in the present example is fabricated by the process shown in FIGS. 3A to 3F.

The insulating coat layer 3 is composed of SiO₂ and is formed by sputtering. Then, on the insulating coat layer 3 is disposed titanium with a film thickness of about 5 nm as an adhesion layer. On the adhesion layer is formed platinum with a film thickness of about 20 nm by a sputtering method. Thereafter, patterning is performed by a lithography method and then dry etching is performed, whereby electrodes 5 and 6 are formed [FIG. 3A].

Then, column-direction wirings 4 are formed on the electrodes 5 by performing printing using a silver paste by a screen printing method, followed by baking [FIG. 3B] Insulating layers 2 are composed of SiO₂ and formed by sputtering. Each insulating layer 2 has openings 2a provided therein so that a corresponding row-direction wiring 1 to be disposed thereon is electrically connected to corresponding electrodes 6 [FIG. 3C]. Row-direction wirings 1 are formed by performing printing using a silver paste by a screen printing method, followed by baking at 420° C. [FIGS. 3D and 3E]. Note that FIG. 3E is a cross-sectional view taking along line A-A′ of FIG. 3D.

Conductive films 7a and 7b are formed by applying a Pd complex solution by an inkjet method so as to contact corresponding electrodes 5 and 6 and then baking the applied film in air. At this time the conductive films are PdO films having palladium oxide as a main component, and the average diameter of the thus formed PdO films for a plurality of electron-emitting devices is 66.3 μm.

Subsequently, forming is performed on the PdO films as follows.

With extraction electrodes for applying a voltage to the row-direction wirings 1 and the column-direction wirings 4 being left, a vacuum envelope which will be described later is sealed to make the atmosphere of all the electron-emitting devices to be vacuum atmosphere containing a little hydrogen. Under this atmosphere, a voltage is applied to the row-direction wirings 1 and the column-direction wirings 4 to reduce the PdO films to Pd films.

The waveform used in the forming is a triangular wave and the wave height is incremented by the order of 0.1 V steps. By this process, a spacing 8 is formed in a part of a Pd film, whereby conductive films 7a and 7b disposed with the spacing 8 therebetween are formed [FIG. 3F].

Then, with all of the electron-emitting devices after the forming being exposed to atmosphere containing tolunitrile, a voltage is applied to the row-direction wirings 1 and the column-direction wirings 4 to deposit carbon in the vicinity of the spacings 8 (activation).

As shown in FIGS. 1 and 2, the face plate is disposed on the thus fabricated rear plate with a gap of 1.6 mm therebetween and with a support frame 9 and the spacers 101 provided therebetween.

A glass frit is applied to a junction between the substrate 12 of the face plate, the support frame 9, and a substrate 11 of the rear plate and baked in the atmosphere, whereby the inside of the image display apparatus is sealed.

The air inside the image display apparatus is exhausted by a vacuum pump through an exhaust pipe (not shown) and thereafter the exhaust pipe is welded to seal the image display apparatus.

L4, L5, and L6 shown in FIG. 11 which are the lengths determining the shape of an insulating surface in one electron-emitting device take the following values:

L4=10 μm

L5=40 μm

L6=145 μm

L in the present example is L=L5/2=20 μm.

At this time,

since Rs×L²=1.6×10²²[Ω×μm²],

Rs×L²<4.2×10²²[Ω×μm²] is satisfied.

The image display apparatus in the present example is driven under the following conditions:

Va=10 kV

Vf=16.8 V

D=1/1080

The drive is performed by scroll drive such that all electron-emitting devices for a selected row are always driven. This is a drive method for the image display apparatus, in which the maximum value of the amount of photoelectrons generated per unit area and time on an insulating surface is provided.

The δxe of the rear plate is δxe=1×10⁻⁴, the δex of the face plate is δex=5.90×10⁴, and Ie=4.5 μA.

The i in this case can be calculated as follows. Note that the maximum value of the amount of change i in charge per unit area and time caused by generation of photoelectrons on insulating surfaces in electron-emitting devices in the row direction during the drive of the apparatus in the present example is iₑₓ₁.

I=(δex×Ie×D/(2×π))Σ(Φ×δxe)=(δex×Ie×D/(2×π))(iₑₓ₁/i_{1d})(Φ×δxe)_{1d}≈4.9×10⁻²¹ [A/μm²]

In the above equation, the following two equations are used.

$$( {i}_{ex 1} / {i}_{1 d} ) = 317 and$$

$$\begin{matrix}{( Φ \times δ xe )}_{1 d} = 3.91 \times {10}^{- 7} [ sr / {µm}^{2} ] \times 1 \times {10}^{- 4} \\ = 3.91 \times {10}^{- 11} [ sr / {µm}^{2} ] .\end{matrix}$$

In the present example, the amount of charge i per unit area and time caused by generation of photoelectrons on insulating surfaces, such as that described above, is provided during drive. During the drive, the maximum potential V on the insulating surfaces is estimated to be increased to the following value.

V=(Rs×i×L²)/2≈39(V)

During the drive, display characteristics that provide visual discomfort, such as deterioration in electron-emitting devices and a sudden change in brightness, are not observed.

### Second Implemental Example

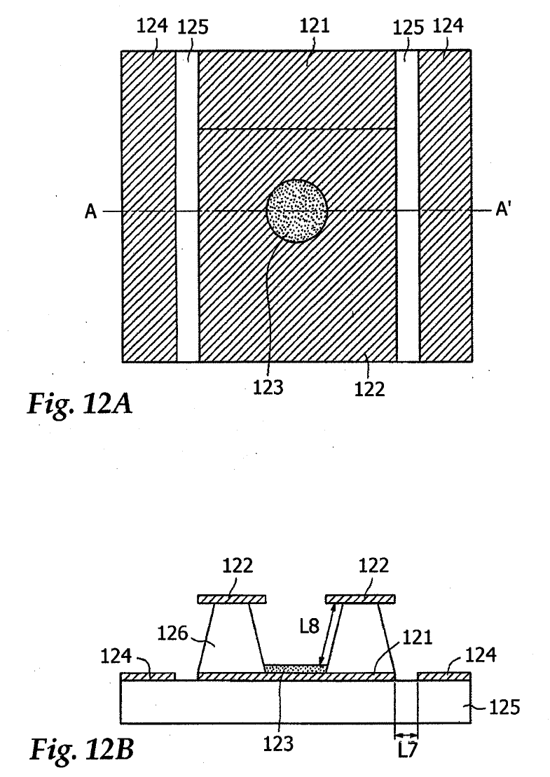

In the present example, a rear plate having one electron-emitting device shown in FIGS. 12A and 12B is fabricated. FIG. 12A is a schematic plan view and FIG. 12B is a schematic cross-sectional view taken along line A-A′ of FIG. 12A. In the drawings, reference numeral 121 denotes an electrode (negative electrode), 122 denotes an electrode (positive electrode), and 123 denotes an electron-emitting portion composed of an aggregate of carbon nanotubes. Reference numeral 124 denotes an electrode (with the same potential as the electrode 121), 125 denotes an insulating substrate, and 126 denotes an insulating layer.

The insulating substrate 125 has SiO₂ as a main component and the insulating layer 126 is composed of SiO₂. The sheet resistivities Rs of the insulating substrate 125 and the insulating layer 126 are about 4×10¹⁹(Ω/□)

A fabrication method of the rear plate in the present example will be briefly described below.

After TiN is sputtered onto the insulating substrate 125 to a thickness of 100 nm, Co with a thickness on average of 10 nm is deposited, as a catalyst metal for carbon nanotubes, on an area where the bottom of a hole structure is located, using a metal mask. Thereafter, the TiN is patterned by a photolithography technique and then by dry etching an electrode 121 is formed.

Thereafter, SiO₂ with a thickness of 3 μm is deposited by plasma CVD and furthermore TiN with a thickness of 100 nm is deposited by sputtering. Then, patterning is performed by a photolithography technique and by dry etching and wet etching an insulating layer 126 and an electrode 122 are formed.

Thereafter, by thermal CVD, carbon nanotubes 123 are formed from the catalyst metal. In the thermal CVD, at room temperature the air inside a furnace is exhausted to 1×10⁻⁵ Pa and thereafter the atmosphere inside the furnace is filled with a hydrogen gas diluted with nitrogen to 2%, to atmospheric pressure and then the temperature inside the furnace is raised to 350° C. Thereafter, an ethylene gas diluted with nitrogen to 1% is allowed to continuously flow into the furnace for three hours.

By the above-described process, a rear plate having one electron-emitting device is fabricated and disposed so as to face a face plate having the same configuration as that in the first implemental example. The gap between the rear plate and the face plate is 1.6 mm and the atmosphere between the rear plate and the face plate is maintained at 1×10⁻⁶ Pa or less.

The FED using carbon nanotubes and configured in the above-described manner is driven by applying Vf between the electrode (negative electrode) 121 and the electrode (positive electrode) 122 and applying Va between the electrode (negative electrode) 121 and an anode (not shown). Va is 10 kV and Vf is 10 V. The drive is performed with a pulse width of 1 ms with respect to a cycle of 10 ms. Thus, the duty cycle D is 1/10.

At this time, the current Ie from the carbon nanotubes to the anode is Ie≈30 μA.

The δxe of the rear plate is δxe=1×10⁻⁴, and the δex of the face plate is δex=5.90×10⁻⁴.

In the present example, since there is only one electron-emitting device,

Σ(Φ×δxe)=(Φ×δxe)_{1d}≈3.91×10⁻¹¹[sr/μm²].

At this time, i is estimated as shown in the following equation.

i=(δex×Ie×D/(2×π))Σ(Φ×δxe)≈1.0×10⁻²⁰ [A/μm²]

In the electron-emitting device in the present example, L7 and L8 in FIG. 12B are

L7=60 μm and

L8=3 μm.

An insulating surface of a shape determined by L7 and an insulating surface of a shape determined by L8 are separated from each other by the electrode (negative electrode) 121. In this case, since L7>L8, L of an insulating surface of the electron-emitting device is determined by L7 and is as shown in the following equation:

L=L7/2=30 μm

Rs is, as described above, 4×10¹⁹(Ω/□). Accordingly,

since Rs×L²=3.6×10²²[Ω/μm²],

Rs×L²<4.2×10²²[Ω/μm²] is satisfied.

The potential of the insulating surface at this time is estimated such that

V=(Rs×i×L²)/2≈185(V).

During the drive, display characteristics that provide visual discomfort, such as deterioration in the electron-emitting device and a sudden change in brightness, are not observed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-239156, filed on Sep. 18, 2008, which is hereby incorporated by reference herein in its entirety.

What is claimed is:

1. An image display apparatus comprising:
a first substrate having a base with an insulating surface; an electron-emitting device formed on the base; wirings connected to the electron-emitting device; and an insulating member that insulates a conductive member including the wirings and electrodes of the electron-emitting device; and
a second substrate having an anode facing the electron-emitting device; and a light emitting member that emits light by irradiation of electrons emitted from the electron-emitting device, and disposed so as to face the first substrate, wherein
a shortest distance L [μm] from an arbitrary point on each of an exposed surface of the surface of the base and an exposed surface of the insulating member, to the conductive member, and sheet resistivities Rs [Ω/□] of the surface of the base and the insulating member satisfy a following equation (1):
Rs×L²<4.2×10²²[Ω×μm²] (1)

2. An image display apparatus according to claim 1, wherein the L and the Rs satisfy a following equation (2):
Rs×L²<1.8×10²¹[Ω×μm²] (2)

3. An image display apparatus according to claim 1, wherein the surface of the base and the insulating member have silicon oxide as a main component and have a sheet resistivity of 1×10¹⁶ Ω/□ or more.

4. An image display apparatus according to claim 2, wherein the surface of the base and the insulating member have silicon oxide as a main component and have a sheet resistivity of 1×10¹⁶ Ω/□ or more.
